(19) United States
(12) Patent Application Publication
(10) Pub. No.: US 2012/0195381 A1
(43) Pub. Date: Aug. 2, 2012

(54) IMAGE PROCESSING APPARATUS AND METHOD FOR PROCESSING IMAGE

(75) Inventors: Yasuhiro WATANABE, Kawasaki (JP); Kiyonori Morioka, Kawasaki (JP); Noboru Yoneoka, Kawasaki (JP)

(73) Assignee: FUJITSU LIMITED, Kawasaki-shi (JP)

(21) Appl. No.: 13/360,382

(22) Filed: Jan. 27, 2012

(30) Foreign Application Priority Data
Feb. 2, 2011 (JP) 2011-20723

(51) Int. Cl. H04N 7/46; H04N 7/32

(52) U.S. Cl. 375/240.15; 375/240.12; 375/E07.243; 375/E07.25

(57) ABSTRACT

An image processing apparatus includes a subsampling circuit to generate a subsampled image based on a sampling position of each frame of an input image; a control circuit to assign a frame at a sampling position which is substantially the same as a sampling position of a frame to be encoded as a reference frame based on information of the sampling position of each frame and a structure of a group of pictures; and an encoder to encode the frame to be encoded by compressing the frame to be encoded using inter-frame prediction based on a subsampled image of the frame to be encoded and the reference frame.

### CROSS-REFERENCE TO RELATED APPLICATIONS

This application claims the benefit of priority from Japanese Patent Application No. 2011-20723 filed on Feb. 2, 2011, the entire contents of which are incorporated herein by reference.

### FIELD

Embodiments relate to an image processing apparatus and a method for processing an image.

### BACKGROUND

When a moving image sequence is recorded, for example, the moving image sequence is compressed according to a moving image encoding standard adopting inter-frame prediction, such as H.264/MPEG-4 Advanced Video Coding (AVC).

The related art is disclosed in Japanese Unexamined Patent Application Publication No. 2001-145009, Japanese Unexamined Patent Application Publication No. 2008-085674, and the like.

### SUMMARY

According to one aspect of the embodiments, an image processing apparatus includes: a subsampling circuit to generate a subsampled image based on a sampling position of each frame of an input image; a control circuit to assign a frame at a sampling position which is substantially the same as a sampling position of a frame to be encoded as a reference frame based on information of the sampling position of each frame and a structure of a group of pictures; and an encoder to encode the frame to be encoded by compressing the frame to be encoded using inter-frame prediction based on a subsampled image of the frame to be encoded and the reference frame.

Additional advantages and novel features of the invention will be set forth in part in the description that follows, and in part will become more apparent to those skilled in the art upon examination of the following or upon learning by practice of the invention.

### BRIEF DESCRIPTION OF DRAWINGS

FIG. 1 illustrates an exemplary image process;

FIG. 2 illustrates an exemplary image process;

FIG. 3 illustrates an exemplary image process;

FIG. 4 illustrates an exemplary image process system;

FIG. 5 illustrates an exemplary image process;

FIG. 6 illustrates an exemplary image process;

FIG. 7 illustrates an exemplary operation of a moving image recording apparatus;

FIGS. 8A and 8B illustrate an exemplary input image management table and an exemplary reference image management table;

FIG. 9 illustrates an exemplary process for generating information;

FIGS. 10A and 10B illustrate an exemplary input image management table and an exemplary reference image management table;

FIG. 11 illustrates an exemplary process for generating information;

FIG. 12 illustrates an exemplary process for generating information;

FIG. 13 illustrates an exemplary registration process;

FIG. 14 illustrates an exemplary generation of a reference list;

FIG. 15 illustrates an exemplary image processing system;

FIG. 16 illustrates an exemplary image process;

FIG. 17 illustrates an exemplary generation of an interpolated image;

FIG. 18 illustrates an exemplary image process;

FIG. 19 illustrates an exemplary image process;

FIG. 20 illustrates an exemplary image process; and

FIG. 21 illustrates an exemplary process for generating information.

### DESCRIPTION OF EMBODIMENTS

A moving image sequence is compressed, for example, according to a moving image encoding standard adopting inter-frame prediction, such as H.264.

When a plurality of images whose positions of pixels are different from one another are recorded as a moving image sequence, the encoding efficiency may be reduced when compared with a moving image sequence in which the positions of pixels are constant is recorded.

When a moving image is compressed, time redundancy may be reduced by obtaining a difference between a reference image on a block-by-block basis, for example, a reference frame and a current image, for example, a current frame.

In a sequence having an IPPP structure in which the display order (input order) and the encoding order are substantially the same, an image located immediately before a current image may be used as a reference image, for example.

Since the movement vector is zero when there is no noise or the like in a moving image sequence whose positions of pixels are fixed, the difference between a reference image and a current image may become zero. Therefore, the compression ratio may be high.

Since the positions of pixels are different between a reference image and a current image in a moving image sequence whose positions of pixels are not constant, the difference may not become zero. Since the difference become large in high frequency portions such as an edge of an object, the compression ratio may become low.

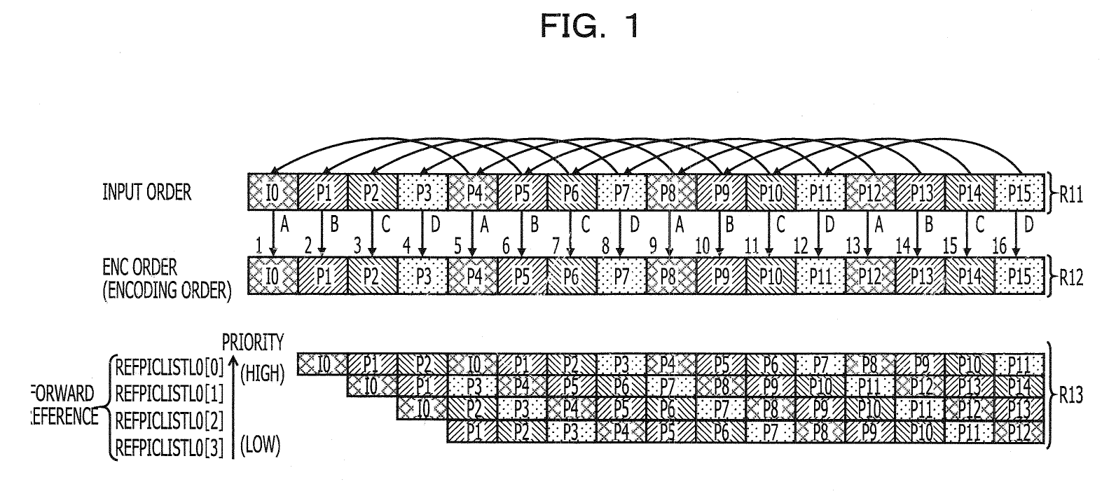

FIG. 1 illustrates an exemplary image process. FIG. 1 illustrates a stream to be encoded for which forward prediction is used. The stream may be encoded using the forward prediction. In accordance with a cyclic period F of sampling positions, for example, F=4, a frame located F (e.g., 4) frames before a frame to be encoded may be used as a first priority forward reference frame.

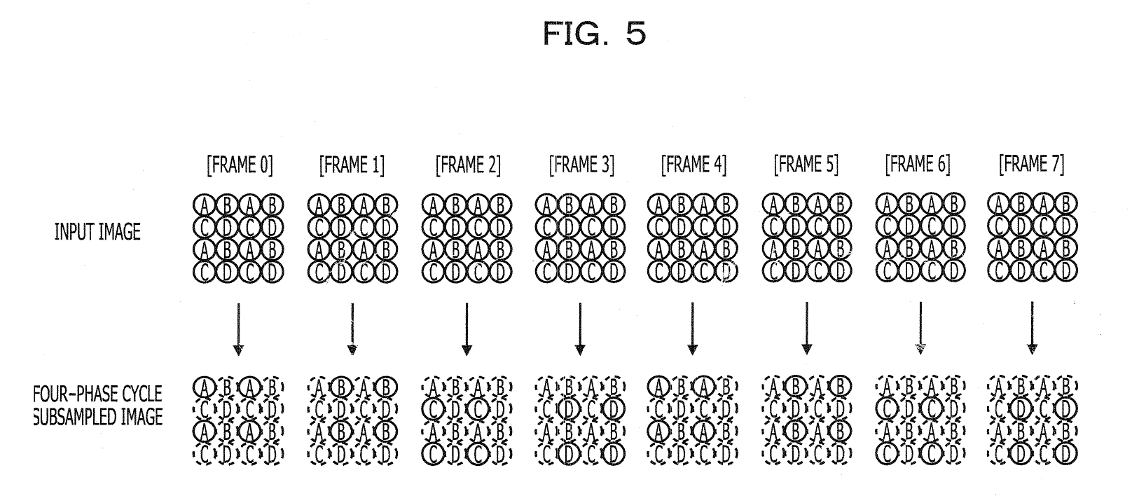

For example, reference images may be assigned in a four-phase cycle. In the four-phase cycle, the sampling positions of A, B, C, D, A, B, C, D, and so on are changed in four phases in a 4×4=16 pixel region illustrated in FIG. 5

For example, a low-resolution image of full high definition (full HD: 1920×1080 pixels: 2k×1k) may be extracted from a high-resolution image of 4k×2k (3840×2160 pixels) in a cyclic period of 4 (four phases).

An intra-coded frame (I-frame), for example, an 10 frame, may be a frame to be encoded without using inter-frame prediction. Predictive frames (P-frames), for example, P1 to P15 frames may be frames to be encoded by using forward prediction. The P1 to P15 frames may be frames to be encoded by using only forward prediction. The I-frame and the P-frames may be substantially the same in the other drawings.

As illustrated in FIG. 1, I0, P1, P2, P3, P4, P5, P6, and so on in an upper region R11 represent the input order of frames (pictures). I0, P1, P2, P3, P4, P5, P6, and so on in an intermediate region R12 represent the order of a process for encoding the frames (ENC order). For example, the input order and the ENC order of the frames may be substantially the same.

Four-layer frames of RefPicListL0[0] to RefPicListL0[3] in a lower region R13 represent the priority order of forward reference frames in relation to the ENC order of the frames.

RefPicListL0[0] represents first priority forward reference frames and RefPicListL0[1] represents second priority forward reference frames. RefPicListL0[2] represents third priority forward reference frames and RefPicListL0[3] represents fourth priority forward reference frames. For example, in the forward reference frames RefPicListL0, [0] may represent first priority frames, and the priority may become lower as the number increases from [1] to [2], and then to [3].

As illustrated in FIG. 1, a frame located four frames before a frame to be encoded, for example, a frame behind one period may be assigned to the frame to be encoded, for example, a current frame as a first priority forward reference frame (RefPicListL0[0]).

For example, a frame I0, which is located four frames prior to a frame P4 to be encoded and in the same phase as the frame P4, may be used as a first priority forward reference frame. A frame P1, which is located four frames prior to a frame P5 to be encoded and in the same phase as the frame P5, may be used as a first priority forward reference frame.

A frame P2, which is located four frames prior to a frame P6 to be encoded and in the same phase as the frame P6, may be used as a first priority forward reference frame. A frame P3, which is located four frames prior to a frame P7 to be encoded and in the same phase as the frame P7, may be used as a first priority forward reference frame.

In the image process illustrated in FIG. 1, since the sampling positions are changed in four phases, a first priority forward reference frame (RefPicListL0[0]) may correspond to a frame located prior to a frame to be encoded and in the same phase as the frame to be encoded.

A second priority forward reference frame (RefPicListL0[1]) may correspond to a frame located one frame prior to a frame to be encoded. A third priority forward reference frame (RefPicListL0[2]) may correspond to a frame located two frames prior to a frame to be encoded. A fourth priority forward reference frame (RefPicListL0[3]) may correspond to a frame located three frames prior to a frame to be encoded.

For example, in the case of the frame P4 to be encoded, the second priority forward reference frame may be the frame P3, the third priority forward reference frame may be the frame P2, and the fourth priority forward reference frame may be the frame P1.

For example, in the case of the frame P7 to be encoded, the second priority forward reference frame may be the frame P6, the third priority forward reference frame may be the frame P5, and the fourth priority forward reference frame may be the frame P4.

When a moving image is compressed, control of the sampling positions of an input image and control of the structure of a group of pictures (GOP) in encoding of the moving image and reference frames of frames to be encoded coordinate with each other. For example, a frame whose sampling positions are in substantially the same phase as those of a frame to be encoded may be preferentially used as a reference frame.

For example, in H.264, a reference list may be generated so that higher priority reference frames are listed in smaller reference index numbers. Cost may be weighted so as to select the higher priority reference frames preferentially based on results of detection of movement vectors.

For example, when moving vectors are detected, the sum of absolute differences (SAD) between a current macroblock and a reference macroblock may be used as cost.

Judgment cost may be obtained by weighting cost calculated based on the SAD for each reference frame. For example, the judgment cost may be obtained by a formula “Judgment cost=Cost calculated based on the SAD+Weight on a reference frame”.

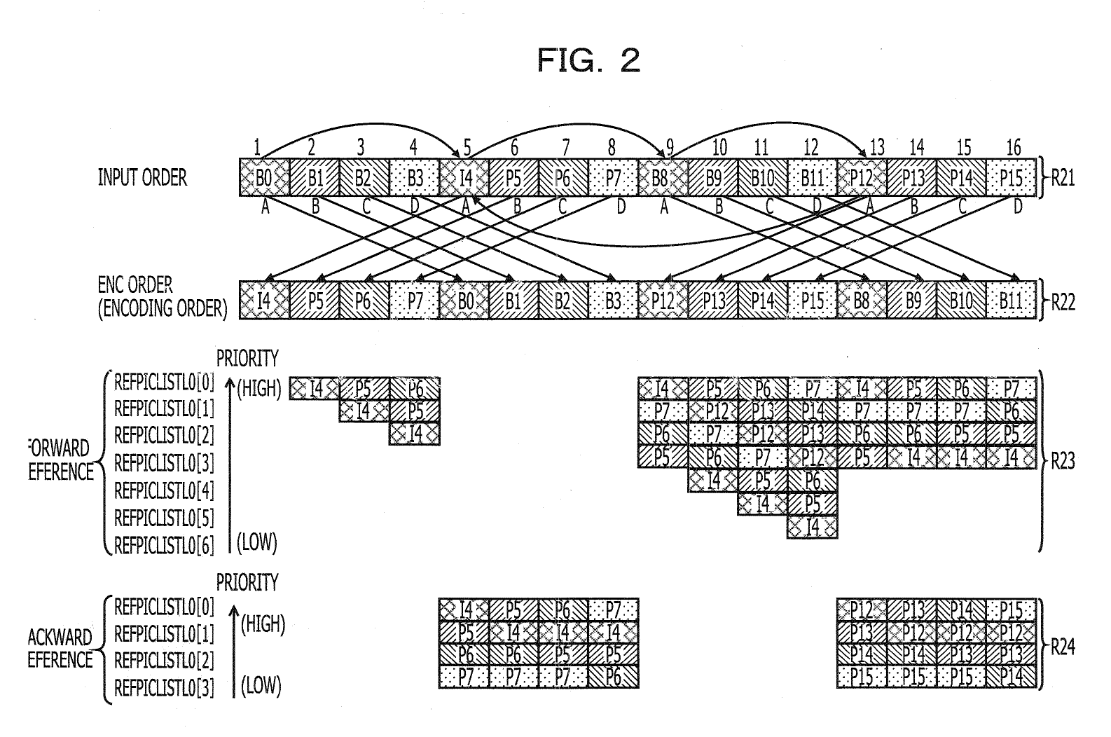

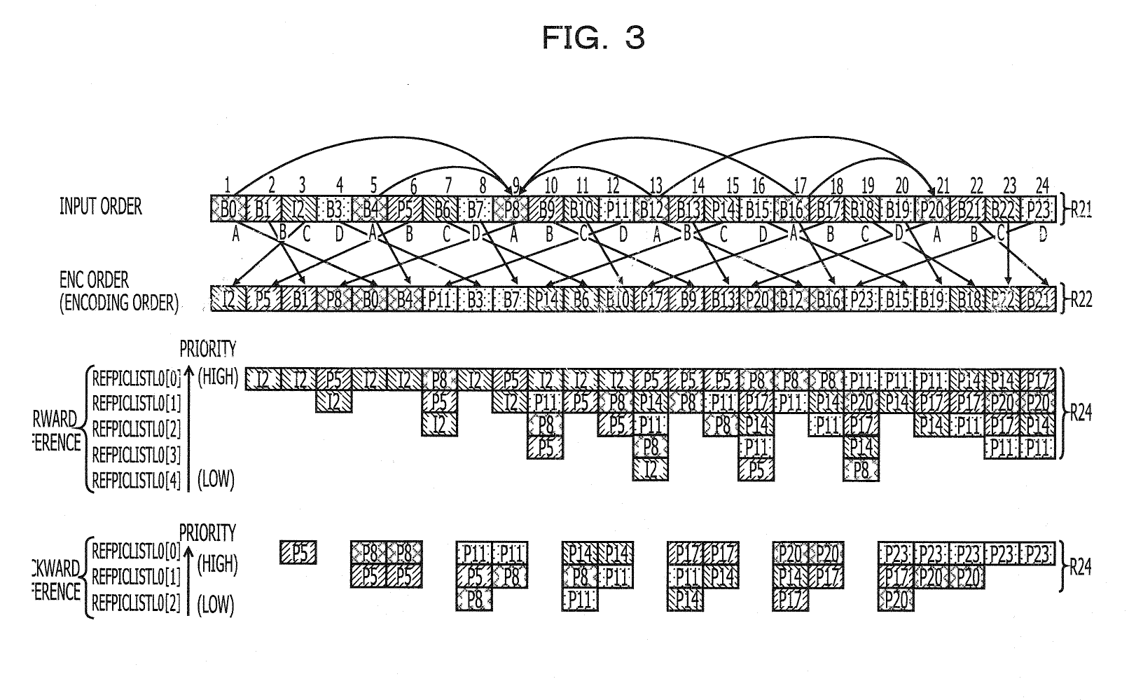

When a weight on a high priority reference frame is set to a small value, vectors in the high priority reference frame are likely to be selected. The calculation formula may be applied to the image processes illustrated in FIGS. 2 and 3.

Because the sampling positions of a frame to be encoded substantially match with a reference frame, the differences between a current image block and a reference image block becomes small in still regions, thereby improving the compression ratio.

Because a reference frame substantially in the same sampling position as the reference index 0, for example, a first priority reference frame, is assigned, the compression ratio may be improved.

Although the compression efficiency of a skipped macroblock, for which differences in vectors and difference data are not transmitted, is high because the movement vectors is predicted from spatiotemporally adjacent blocks, the reference index 0 may be used as a reference image.

Even if a camera and an object are still, the sampling positions of a reference image of the reference index 0, for example, a reference frame may not be substantially the same as those of a current image, for example, a current frame. Therefore, differences may be generated in high frequency regions such as an edge of the object, and a skip may not occur.

When a reference frame whose sampling positions are substantially the same as those of a current frame is assigned to the reference index 0, a skip may occur because the reference frame whose sampling positions are substantially the same as that of the current frame is used as a reference image for the skip.

FIG. 2 illustrates an exemplary image process. In FIG. 2, an encoding stream that includes bi-predictive frames (B-frames) may be used. For example, B-frames illustrated in FIG. 2, for example, B0 to B3 and B8 to B11 frames may be encoded based on at least one of forward prediction, backward prediction and bidirectional prediction.

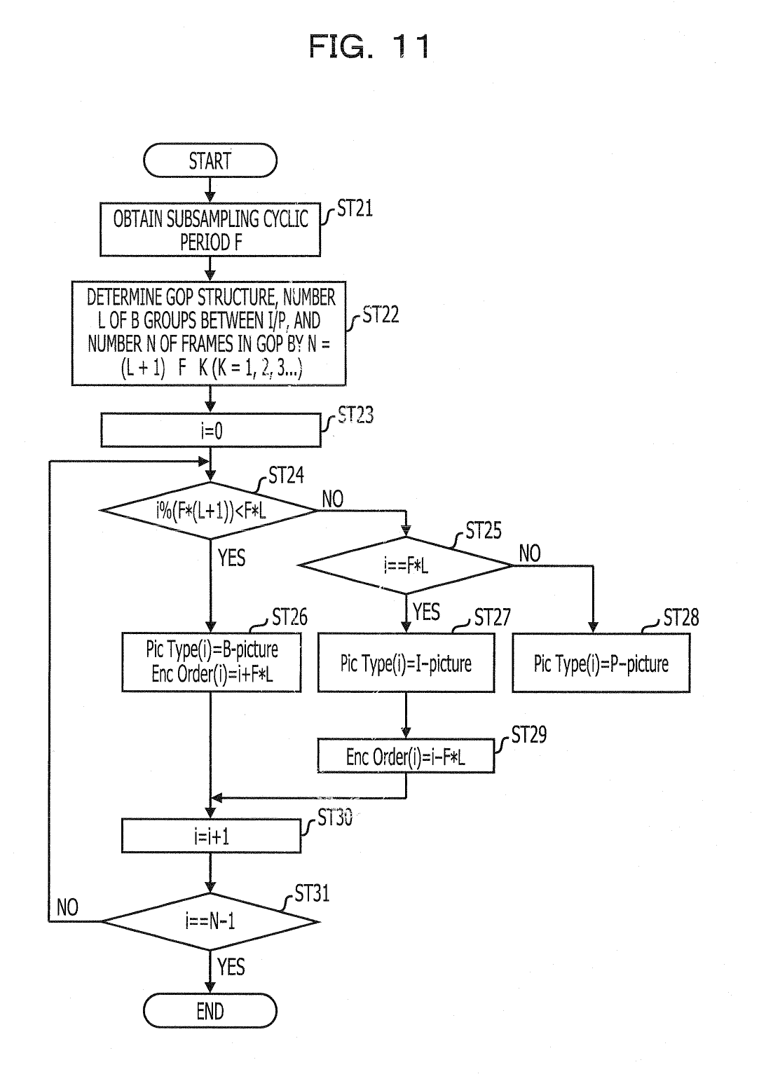

If the cyclic period F of sampling positions is 4, F (4) consecutive frames in the input order may configure the GOP, and the picture type (I, P, or B) may be assigned for each of the frames. For example, the number L of groups of four B-frames illustrated in FIG. 11 may be 1.

In the GOP structure, an I-frame or a P-frame that is located prior to the frame to be encoded in the input order and whose sampling positions are substantially the same as those of a frame to be encoded may be assigned to the frame to be encoded as a first priority forward reference frame. An I-frame or a P-frame that is located behind the frame to be encoded in the input order and whose sampling positions are substantially the same as those of the frame to be encoded may be assigned to the frame to be encoded as a first priority backward reference frame.

B0, B1, B2, B3, I4, P5, P6, and so on in an uppermost region R21 illustrated in FIG. 2 represent the input order of frames. I4, P5, P6, P7, B0, B1, B2, and so on in a second region R22 from the top represent the ENC order of the frames.

Seven-layer frames in a third region R23 from the top illustrated in FIG. 2, for example, RefPicListL0[0] to RefPicListL0[6], represent forward reference frames of the frames arranged in the ENC order. RefPicListL0[0] represents first priority forward reference frames, RefPicListL0[1] represents second priority forward reference frames, and so on, and RefPicListL0[6] represents seventh priority forward reference frames.

Four-layer frames in a lowest region R24 illustrated in FIG. 2, for example, RefPicListL1[0] to RefPicListL1[3], represent backward reference frames of the frames arranged in the ENC order.

RefPicListL1[0] represents first priority backward reference frames, RefPicListL1[1] represents second priority backward reference frames, RefPicListL1[2] represents third priority backward reference frames, and RefPicListL1[3] represents fourth priority backward reference frames. For example, in the backward reference frames RefPicListL1, [0] may represent first priority frames, and the priority may become lower as the number increases from [1] to [2], and then to [3].

An I-frame or a P-frame that is located prior to a frame to be encoded in the input order and whose sampling positions are substantially the same as those of the frame to be encoded may be used as a first priority forward reference frame. An I-frame or a P-frame whose sampling positions are substantially the same as those of the frame to be encoded after input may be used as a first priority backward reference frame.

For example, a frame I4, which is located four frames prior to the frame B8 and is in the same phase as the frame B8, may be assigned to the frame B8 as a first priority forward reference frame. The frame P12, which is located four frames behind the frame B8 and in is the same phase as the frame B8, may be assigned to the frame B8 as a first priority backward reference frame.

The frame B8 to be encoded may use the frame P7 located immediately before the frame B8 as a second priority forward reference frame, and the frame P13 located immediately after the frame P12 as a second priority backward reference frame.

For example, the frame P7, which is located four frames behind the frame B11 and is in the same phase as the frame B11, may be assigned to the frame B11 as a first priority forward reference frame, and the frame P15, which is located four frames behind the frame B11 and is in the same phase as the frame B11, may be assigned to the frame B11 as a first priority backward reference frame.

The frame P6 located immediately prior to the frame P7 may be assigned to the frame B11 to be encoded as a second priority forward reference frame, and the frame P12 located immediately behind may be assigned to the frame B11 as a second priority backward reference frame.

For example, since a frame located four frames prior to the frame P12 to be encoded is a B-frame, for example, the frame B8, the frame 14, which is located eight frames prior to the frame P12 and is in substantially the same phase as the frame P12 may be assigned to the frame P12 as a first priority forward reference frame.

The frame P7, which is the I-frame or P-frame located prior to the frame P12, for example, five frames prior to the frame P12 may be assigned to the frame P12 as a second priority forward reference frame. The frame P6 located six frames prior to the frame P12 may be assigned to the frame P12 to be encoded as a third priority forward reference frame, and the frame P5 located seven frames prior to the frame P12 as a fourth priority forward reference frame.

For example, since a frame located four frames prior to the frame P15 to be encoded is a B-frame, for example, the frame B3, the frame P15 may use the frame P7, which is located eight frames prior to the frame P15 and is in substantially the same phase as the frame P15, as a first priority forward reference frame, and the frame P14 located immediately prior to before the frame P15 may be assigned as a second priority forward reference frame.

The frame P13 located two frames prior to the frame P15 may be assigned to the frame P15 as a third priority forward reference frame, and the frame P12 located three frames prior to the frame P15 may be assigned as a fourth priority forward reference frame.

The frame P6 located immediately prior to the frame P7 may be assigned to the frame P15 as a fifth priority forward reference frame, the frame P5 located two frames prior to the frame P7 may be assigned as a sixth priority forward reference frame, and the frame 14 located three frames prior to the frame P7 may be assigned as a seventh priority forward reference frame.

An I-frame or a P-frame that is located prior to the frame to be encoded in the input order and whose sampling positions are substantially the same as those of the frame to be encoded may be assigned to the frame to be encoded as a first priority forward reference frame. An I-frame or a P-frame that is located behind the frame to be encoded in the input order and whose sampling positions are substantially the same as those of the frame to be encoded may be assigned as a first priority backward reference frame.

Since the B-frames are used in addition to the I-frame and the P-frame illustrated in FIG. 1, the compression ratio may be improved.

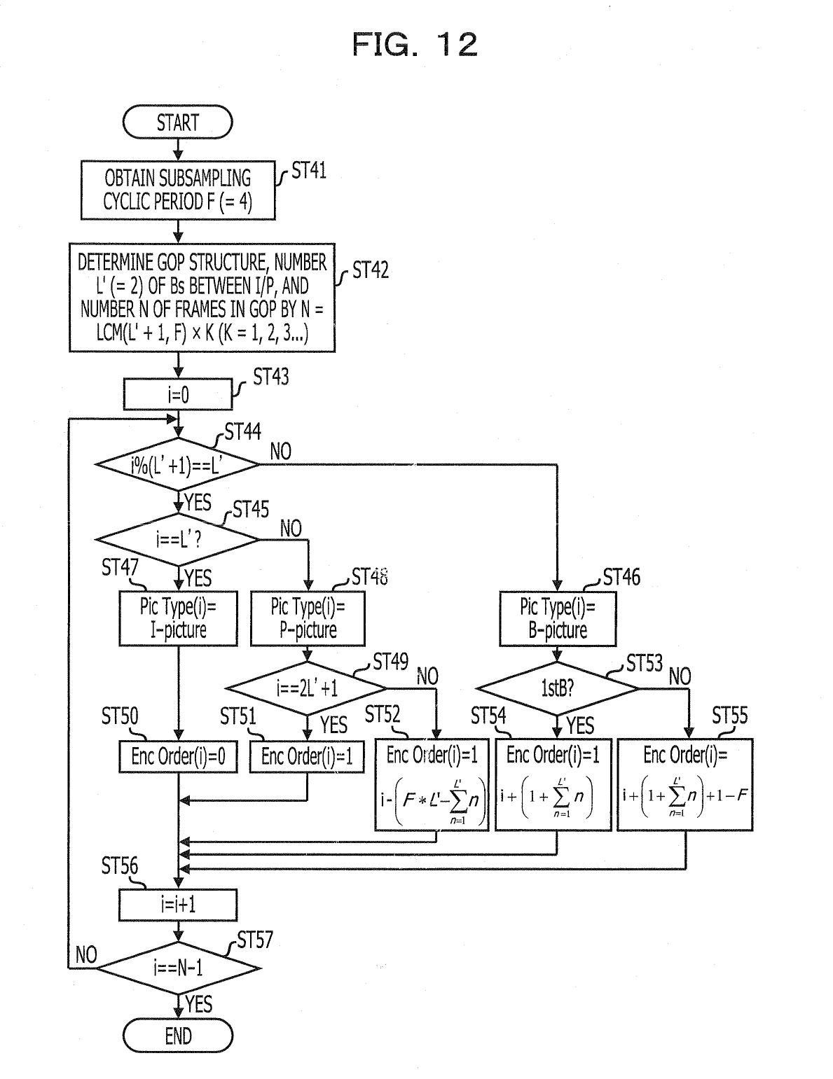

FIG. 3 illustrates an exemplary image process. In FIG. 3, a GOP structure in which B-frames are used as in the image process illustrated in FIG. 2. For example, if the cyclic period F of sampling positions is 4, an I-frame or a P-frame may appear every M frames (where M is relatively prime to F). For example, in FIG. 3, an I-frame and P-frames appear with two B-frames sandwiched therebetween. For example, the number L′ of Bs between I/P illustrated in FIG. 12 may be 2.

The GOP may be constructed by sampling phases and picture types, for example, the distinction between I or P (I/P) and B, with a multiple of F×M frames of each cycle. In the GOP structure, an I-frame or a P-frame that is located closest to a frame to be encoded in the input order before the frame to be encoded and whose sampling positions are the same as those of the frame to be encoded may be used as a first priority forward reference frame.

An I-frame or a P-frame that is located behind the frame to be encoded in the input order and whose sampling positions are substantially the same as those of the frame to be encoded may be used as a first priority backward reference frame.

In FIG. 3, B0, B1, I2, B3, B4, P5, B6, and so on in an uppermost region R31 represent the input order of the frames. I2, P5, B1, P8, B0, B4, P11, and so on in a second region R32 from the top represent the ENC order of the frames.

Five-layer frames in a third region R33 from the top, for example, RefPicListL0[0] to RefPicListL0[4], represent forward reference frames of the frames arranged in the ENC order. Three-layer frames in a lowest region R34, for example, RefPicListL1[0] to RefPicListL1[2], represent backward reference frames of the frames arranged in the ENC order.

A GOP includes a multiple of F×M frames of sampling phases and picture types, for example, the distinction between I/P and B.

In the GOP structure, an I/P-frame that is located prior to the frame to be encoded in the input order and whose sampling positions are substantially the same as those of the frame to be encoded may be used as a first priority forward reference frame. An I/P-frame that is located behind the frame to be encoded in the input order and whose sampling positions are substantially the same as those of the frame to be encoded may be used as a first priority backward reference frame.

For example, since a frame located four frames prior to the frame B10 to be encoded is a B-frame, for example, the frame B6, the frame I2, which is located eight frames prior to the frame B10 and is in substantially the same phase as the frame B10, may be used as a first priority forward reference frame.

Since a frame located immediately prior to the frame B10 to be encoded is a B-frame, for example, the frame B9, the frame P8, which is located two frames prior to the frame B10, may be used as a second priority forward reference frame. The frame P5, which is an I/P (I or P) frame located prior to the frame P8 and located five frames prior to the frame B10, may be used as a third priority forward reference frame.

The frame P14, which is located four frames behind the frame B10 to be encoded and is in substantially the same phase as the frame B10, may be used as a first backward reference frame, and the frame P11, which is located immediately behind the frame B10, may be used as a second priority backward reference frame.

Since a frame located four frames prior to the frame B16 to be encoded is a B-frame, for example, the Frame B12, the frame P8, which is located eight frames prior to the frame B16 and is in substantially the same phase as the frame P8, may be used as a first priority forward reference frame.

Since a frame immediately prior to the frame B16 to be encoded is a B-frame, for example, the frame B15, the frame P14, which is located two frames prior to the frame B16, may be used as a second priority forward reference frame. The frame P11, which is an I/P (I or P) frame located prior to the frame P14 and located five frames prior to the frame B16, may be used as a third priority forward reference frame.

The frame P20, which is located four frames behind the frame B16 and is in substantially the same phase as the frame B16 may be assigned to the frame B16 to be encoded as a first priority backward reference frame, and the frame P17, which is located immediately behind the frame B16, as a second priority backward reference frame.

For example, since a frame located four frames prior to the frame P20 to be encoded is a B-frame, for example, the frame B16, and a frame located eight frames prior to the frame P20 to be encoded is a B-frame, for example, the frame B12, the frame P8, which is located twelve frames prior to the frame P20 and is in substantially the same phase as the frame P20, may be assigned as a first priority forward reference frame.

The frame P17, which is a I-frame or P-frame located prior to the frame P20, located three frames prior to the frame P20 may be assigned to the frame B20 to be encoded as a second priority forward reference frame, and the frame P14, which is located six frames prior to the frame P20 may be assigned as a third priority forward reference frame.

A GOP includes a multiple of F×M frames of sampling phases and picture types, for example, the distinction between I/P and B. In the GOP structure, an I-frame or a P-frame whose sampling position (phase) is substantially the same as that of a frame to be encoded and that is located prior to the frame to be encoded in the input order may be assigned as a first priority forward reference frame. An I-frame or a P-frame that is located behind the frame to be encoded in the input order and whose sampling positions are substantially the same as those of the frame to be encoded may be assigned as a first priority backward reference frame.

In FIG. 3, since the B-frames are used in addition to the I-frames and the P-frames illustrated in FIG. 1, the compression ratio may be improved.

The compression efficiency may be improved when a moving image sequence including a plurality of images whose positions of pixels are different from one another is compressed using a moving image encoding standard adopting inter-frame prediction, such as H.264.

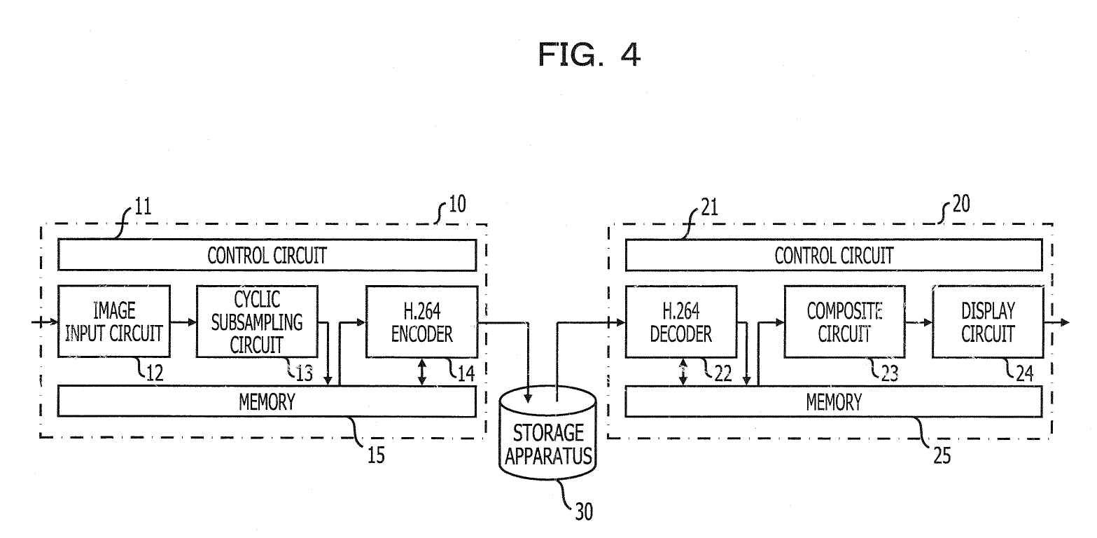

FIG. 4 illustrates an exemplary image process system. A moving image recording apparatus 10, a moving image playing apparatus 20, and a storage apparatus 30 are illustrated.

The moving image recording apparatus 10 includes a control circuit 11, an image input circuit 12, a cyclic subsampling circuit 13, an H.264 encoder 14, and a memory 15. The image input circuit 12 may be an image sensor or the like and may provide image data, for example, an image sequence, to the cyclic subsampling circuit 13.

The cyclic subsampling circuit 13 reduces the number of image sequences from the image input circuit 12. Sampling positions may change in a period F, for example, F=4, and subsampled images may be generated and stored in the memory 15.

The H.264 encoder 14 reads the subsampled images from the memory 15 and encodes the subsampled images in accordance with the H.264 (H.264/MPEG-4 AVC) standard. The encoded data is stored in the storage apparatus 30. For example, the above process may be controlled by the control circuit 11 including a central processing unit (CPU).

The moving image playing apparatus 20 includes a control circuit 21, an H.264 decoder 22, a composite circuit 23, a display circuit 24, and a memory 25. The H.264 decoder 22 reads subsampled images from the storage apparatus 30 and decodes the subsampled images in accordance with the H.264 standard. The decoded image data is stored in the memory 25. The composite circuit 23 reads the image data from the memory 25 and generates an interpolated image and the interpolated image is displayed by the display circuit 24.

For example, an image supplied from the image input circuit 12 to the cyclic subsampling circuit 13 and an image composited by the composite circuit 23 and displayed by the display circuit 24 may be high-resolution images such as images of 4k2k. For example, the subsampled image generated by the cyclic subsampling circuit 13 and an image supplied to the composite circuit 23 may be low-resolution images such as images of full HD.

For example, the moving image recording apparatus 10, the moving image playing apparatus 20, and the storage apparatus 30 may be provided in a single apparatus such as a camcorder. The moving image recording apparatus 10, moving image playing apparatus 20, and the storage apparatus 30 may be provided separately.

For example, the moving image recording apparatus 10 may be an image capturing camera. A moving image captured by the image capturing camera may be stored in the storage apparatus 30 in a wide-area broadcast station, and the moving image playing apparatus 20 in each home that receives wide-area broadcast may play the moving image.

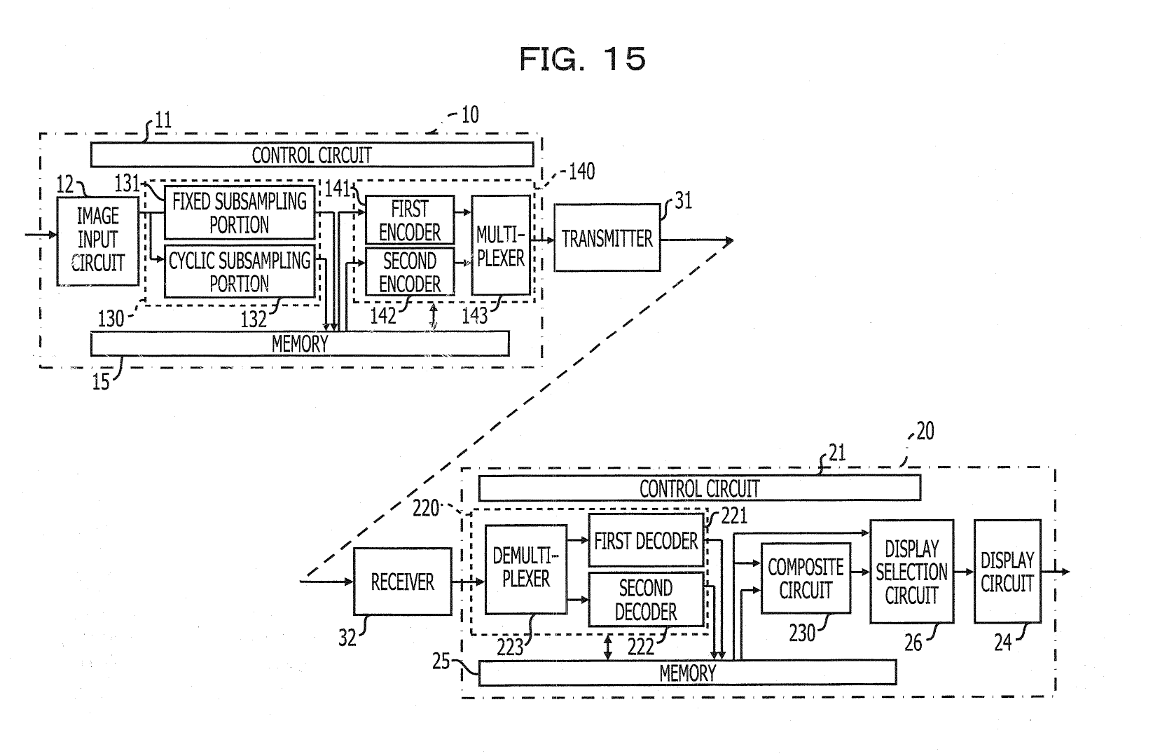

For example, as illustrated in FIG. 15, the moving image recording apparatus 10 and the moving image playing apparatus 20 may be provided separately, and an image from the moving image recording apparatus 10 may be played by the moving image playing apparatus 20 through communication devices, for example, a transmitter 31 and a receiver 32.

In the image process system illustrated in FIG. 4, the moving image recording apparatus 10, the moving image playing apparatus 20, and the storage apparatus 30 may be provided as different apparatuses, or some or all of these apparatuses may be provided as a single apparatus.

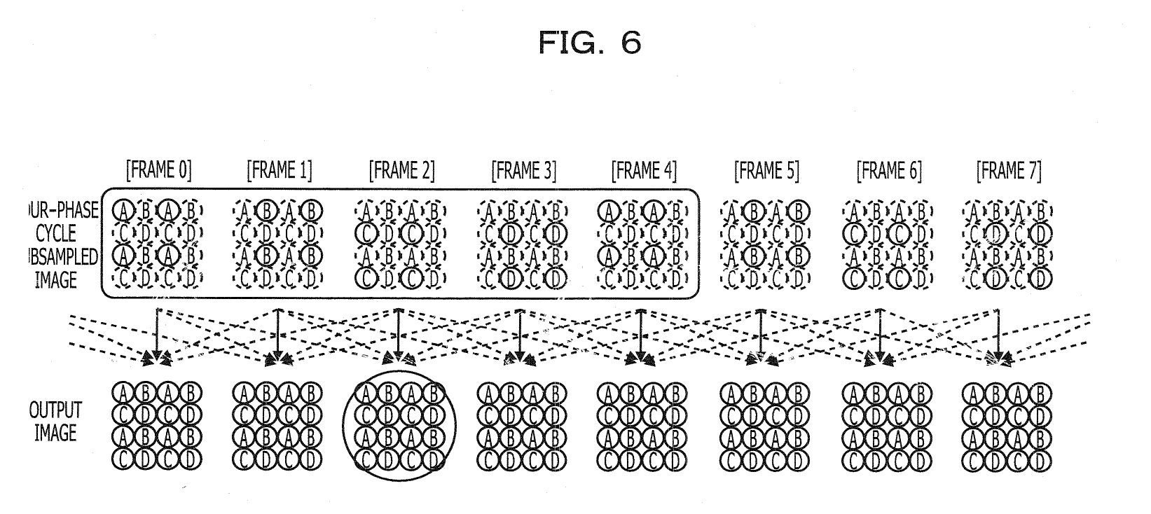

FIG. 5 illustrates an exemplary image process. In FIG. 5, the subsampled image may be generated in a four-phase cycle. FIG. 6 illustrates an exemplary image process. In FIG. 6, interpolated images may be generated from the subsampled image in a four-phase cycle. The process illustrated in FIG. 5 may correspond to the process performed by the cyclic subsampling circuit 13 illustrated in FIG. 4. The process illustrated in FIG. 6 may correspond to the process performed by the composite circuit 23 illustrated in FIG. 4.

In FIG. 5, high-resolution image, for example, input image of 4k2k, or low-resolution images, for example, the subsampled images of full HD, may be generated. In FIG. 5, for example, when each pixel of 4k2k set as a target pixel and surrounding pixels are calculated by a low-pass filter to generate resampled pixels, phases A, B, C, and D are illustrated. 4×4 pixels in 4k2k may be extracted.

A low-pass filter (LPF) has a certain magnitude relative to a central pixel. The magnitude may be, for example, 3×3, 5×5, or an even number. For example, pixel data of a 3×3 or 5×5 region including a pixel (A) located at upper-left corner of a 4×4 pixel region of Frame 0 illustrated in FIG. 5 as a center and surrounding pixels may be input to the LPF, and the LPF may perform sampling in which the number of pixels is reduced, for example, subsampling.

The cyclic subsampling circuit 13 generates the subsampled image by reducing the number of pixels of an image from the image input circuit 12, and writes the subsampled image to the memory 15. As illustrated in FIG. 5, the reducing process performed by the cyclic subsampling circuit 13 may be, for example, ½ reduction in the vertical and horizontal directions. One period may have four stages, for example, four phases A, B, C, and D.

For example, in 4×4=16 pixels, four pixels A may be set as centers of gravity (centers) in a first frame, Frame 0, in order to generate the subsampled image. In the next Frame 1, four pixels B may be set as centers of gravity in order to generate the subsampled image.

In the 4×4=16 pixels, four pixels C may be set as centers of gravity in Frame 2 in order to generate the subsampled image. In the next Frame 3, four pixels D may be set as centers of gravity in order to generate the subsampled image. In Frame 4, the four pixels A may be set as centers of gravity again in order to generate the subsampled image. The above process may be repeated.

The size of the subsampled image generated by reducing the number of pixels by the cyclic subsampling circuit 13; for example, a four-phase cycle subsampled image may be ¼ of those of corresponding input image.

The H.264 encoder 14 reads the subsampled image from the memory 15 and encodes the subsampled image in accordance with H.264. The H.264 encoder 14 may write a local decoded image to the memory 15, or may read a reference image from the memory 15. An H.264 stream generated by the H.264 encoder 14 is written to the storage apparatus 30.

In the moving image playing apparatus 20, the H.264 decoder 22 reads an H.264 stream from the storage apparatus 30 and decodes the H.264 stream. During the decoding, the H.264 decoder 22 may read a reference image from the memory 25 or may write the decoded image to the memory 25.

Since the size of the decoded image written to the memory 25 is ¼ of that of an input image, the composite circuit 23 generates a display image by increasing the size of the decoded image from ¼ to the original size through interpolation. The display image may be displayed by the display circuit 24.

The composite circuit 23 may perform the interpolation using an image located temporally close. For example, detection of movement is performed for each region. In a region in which there is no movement, inter-frame interpolation may be performed using pixels located in corresponding sampling positions of a close frame. In a region in which there is movement, intra-frame interpolation may be performed using surrounding pixels in the own frame.

As illustrated in FIG. 6, when a subsampled image including four pixels C, for example, an interpolated image of Frame 2 in a sampling phase C, is generated, subsampled images of from a first frame, Frame 0, to a fifth frame, Frame 4, may be used.

In the sampling phase C, pixels of the subsampled image may be used, and interpolation may be performed on other sampling phases A, B, and D.

Detection of movement may be performed using Frame 0 and Frame 4, which are in substantially the same sampling phase A. When judging that there is no movement in a region, interpolation of pixels in the sampling phase A, B, and D is performed using images of Frames 0, 1, and 3.

When judging that there is movement in a region, interpolation of pixels in the sampling phases A, B, and D is performed using surrounding pixels of Frame 2 in the sampling phase C.

Since a cyclic phase image sequence is compressed on the recording side, interpolation is performed on the playing side and an image having an original size is generated, the image is recorded with a small amount of data compared to when the original image is directly compressed.

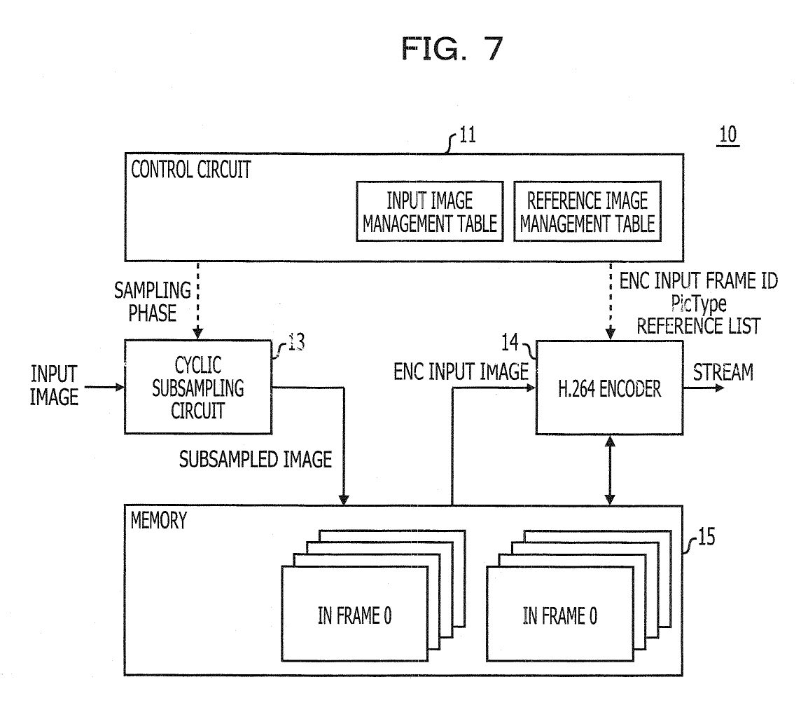

FIG. 7 illustrates an exemplary operation of a moving image recording apparatus. The cyclic subsampling circuit 13 and the H.264 encoder 14 perform certain operations for each frame based on instructions from the control circuit 11.

For example, the cyclic subsampling circuit 13 performs a reducing process in a phase specified by an input image based on a sampling phase instruction from the control circuit 11, and stores a subsampled image in the memory 15.

The H.264 encoder 14 reads an input image to be encoded specified by the control circuit 11 from the memory 15, and encodes the input image in accordance with a specified picture type (PicType) and a reference list.

For example, the control circuit 11 outputs information regarding the GOP of a stream, such as the order of an encoding process (ENC order: EncOrder) and the picture types. For example, the control circuit 11 may output information using an input image management table and a reference image management table.

For example, the control circuit 11 may control the H.264 encoder 14 while updating the input image management table and the reference image management table on a frame-by-frame basis.

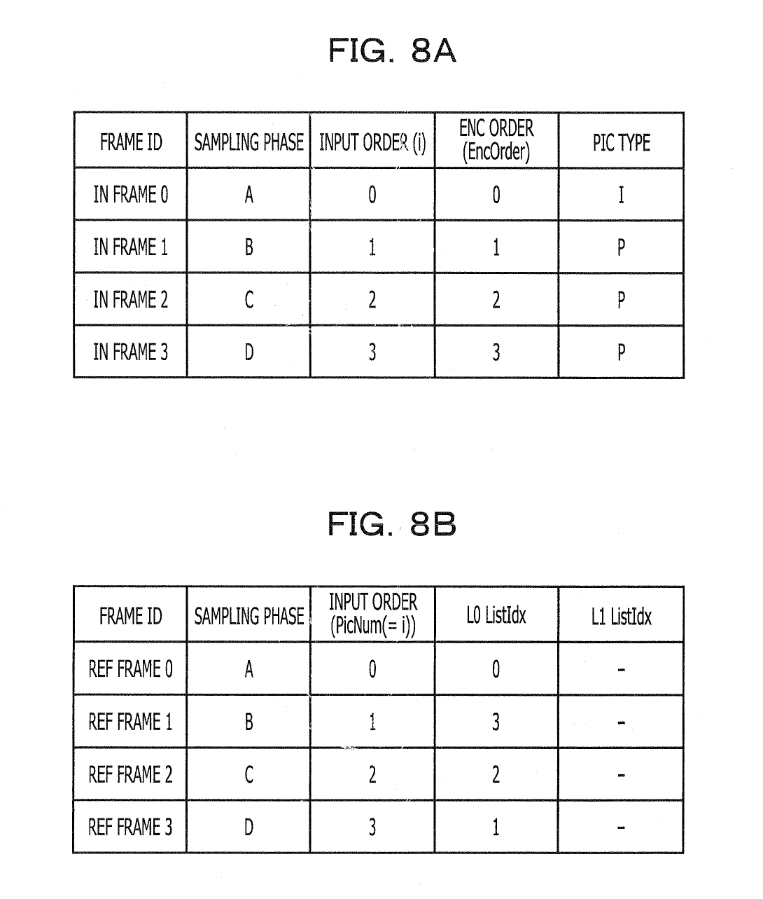

FIGS. 8A and 8B illustrate an exemplary input image management table and an exemplary image management table. FIGS. 8A and 8B illustrate tables corresponding to a sequence having an IPPP structure, which may correspond to the image process illustrated in FIG. 1. FIG. 8A illustrates an input image management table when a frame of i=3 is input. FIG. 8B illustrates a reference image management table when a frame of i=4 is encoded.

As illustrated in FIG. 8A, in the input image management table, sampling phases for frame IDs InFrame0, InFrame1, InFrame2, and InFrame3 may be A, B, C, and D, respectively (F=4). The input order (i) and the ENC order for the frame IDs may be 0, 1, 2, and 3, respectively, and the picture types may be I, P, P, and P, respectively.

For example, in the table illustrated in FIG. 8A, if the input order is I0, P1, P2, and P3 as illustrated in FIG. 1, the ENC order may also be I0, P1, P2, and P3, and the sampling phases may be A, B, C, and D, respectively.

As illustrated in FIG. 8B, in the reference image management table, sampling phases for frame IDs RefFrame0, RefFrame1, RefFrame2, and RefFrame3 may be A, B, C, and D, and the input order (PicNum(=I)) may be 0, 1, 2, and 3, respectively. L0ListIdx for the frame IDs RefFrame0, RefFrame1, RefFrame2, and RefFrame3 may be 0, 3, 2, and 1, respectively.

For example, in the table illustrated in FIG. 8B, the frame I0, which is in the same phase as the frame P4 illustrated in FIG. 1, may be assigned as a first priority forward reference frame to the frame P4. The frames P3, P2, and P1 may be assigned as second, third, and fourth priority forward reference frames, respectively.

In the reference image management table illustrated in FIG. 8B, L0ListIdx represents the priority of each forward reference frame and L1ListIdx represents the priority of each backward reference frame. In FIG. 8B, since the picture types are I and P, L1ListIdx need not be set (“-”). The priority may be highest with “0”, and become lower as the number increases from “1” to “2” and “3”.

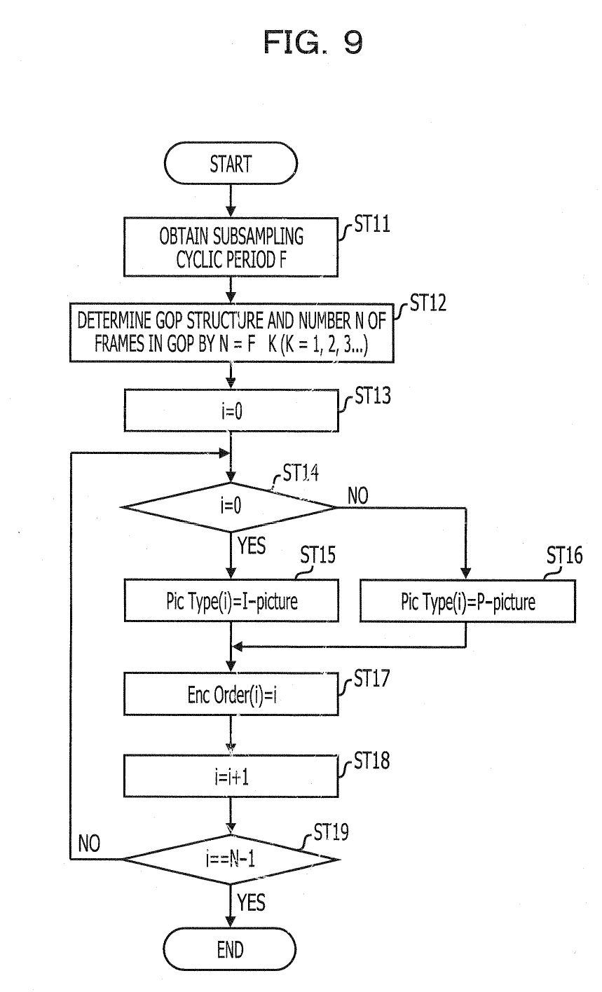

FIG. 9 illustrates an exemplary process for generating information. In FIG. 9, information of an input image management table corresponding to a sequence having an IPPP structure may be generated.

For example, in FIG. 9, information of an input image management table corresponding to the image process illustrated in FIG. 1 may be generated. The picture types (PicType) and the order of an encoding process (EncOrder) for images (frames) in the input order (i) for each GOP are generated.

As illustrated in FIG. 9, when starting generation of the information regarding the input image management table, a sampling cyclic period F is obtained in an operation ST11. In an operation ST12, the GOP structure is determined and the number N of frames in the GOP is set by an expression N=F×K. The process proceeds to an operation ST13. K may be a natural number (K=1, 2, 3, or the like), and N may be a multiple of F.

A GOP corresponding to the cyclic period F of subsampling is set, and the process proceeds to the operation ST13. For example, in FIG. 1, F may be 4 and K may be 4. The number N of frames in the GOP may be N=F×K=4×4=16.

In the operation ST13, i=0 is set, and the process proceeds to an operation ST14. In the operation ST14, whether or not an expression i==0 is established is judged.

If the expression i==0 is established, the picture type (PicType(i)) is set as an I-picture in an operation S15, and the process proceeds to an operation ST17. If the expression i==0 is not established, the picture type is set as a P-picture in an operation ST16, and the process proceeds to the operation ST17.

In the operation ST17, the ENC order is set as i (EncOrder(i)=i). In an operation ST18, 1 is added to i (i=l+1), and the process proceeds to an operation ST19.

In the operation ST19, whether or not an expression i==N−1 is established is judged. If the expression i==N−1 is not established, the process returns to the operation ST14, and substantially the same process may be repeated. If the expression i==N−1 is established, for example, when the process performed for the number N of frames in the GOP, for example, the process performed for sixteen frames of i=0 to 15, is completed, the process for generating the information of the input image management table is terminated.

The input image management table illustrated in FIG. 8A or an input image management table including information corresponding to the frame arrangement illustrated in FIG. 1 is generated. For example, the image process (image compression) illustrated in FIG. 1 may be performed using the input image management table.

The sampling cyclic period F is not limited to 4, and may be any number.

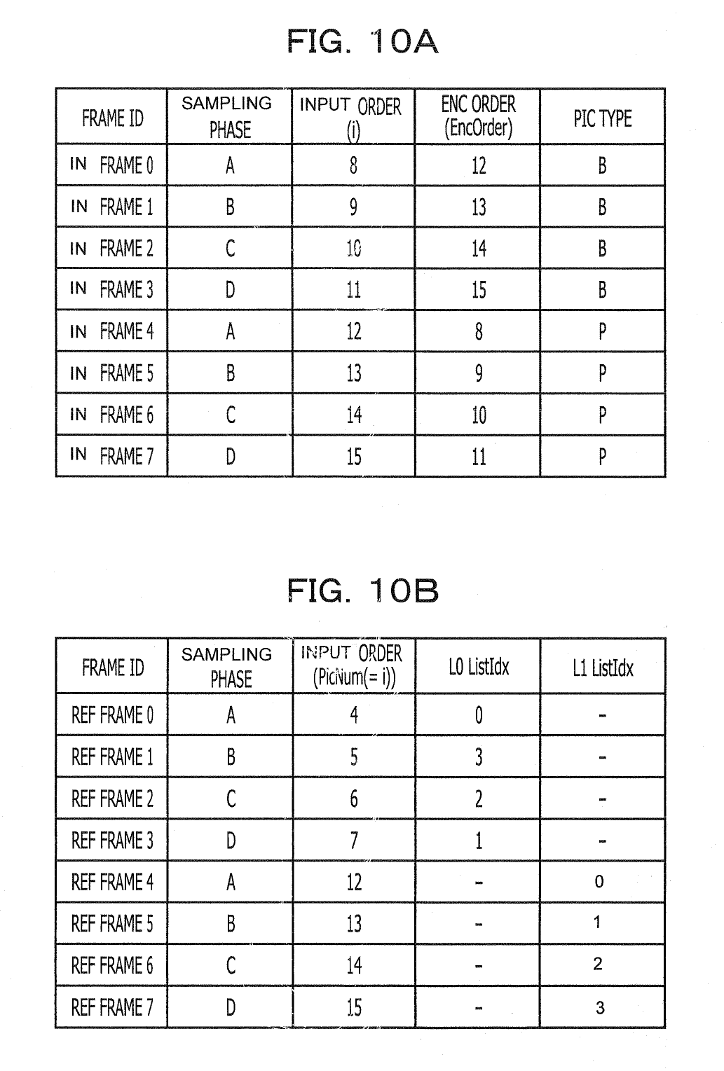

FIGS. 10A and 10B illustrate an exemplary input image management table and an exemplary reference image management table. FIGS. 10A and 10B illustrate tables corresponding to a sequence having an IPB structure, which may correspond to the image process illustrated in FIG. 2. FIG. 10A illustrates an input image management table when a frame of i=15 is input. FIG. 10B illustrates a reference image management table when a frame of i=8 are encoded.

As illustrated in FIG. 10A, in the input image management table, sampling phases for frames IDs InFrame0, InFrame1, InFrame2, InFrame3 . . . InFrame6, and InFrame7 may be A, B, C, D . . . C, and D, respectively (F=4).

In the input image management table, the ENC order for the input order (i) of 8, 9, 10, 11, 12, 13, 14, and 15 may be 12, 13, 14, 15, 8, 9, 10, and 11, respectively, and the picture types may be B, B, B, B, P, P, P, and P, respectively.

For example, in the table illustrated in FIG. 10A, the ENC order corresponding to the input order of B8, B9, B10, B11, P12, P13, P14, and P15 illustrated in FIG. 2 may be P12, P13, P14, P15, B8, B9, B10, and B11, respectively, and the sampling phases may be A, B, C, D, A, B, C, and D, respectively.

As illustrated in FIG. 10B, in the reference image management table, sampling phases for frame IDs ReFrame0, ReFrame1, ReFrame2, ReFrame3, ReFrame4, ReFrame5, ReFrame6, and ReFrame7 may be A, B, C, D, A, B, C, and D, respectively.

The input order may be 4, 5, 6, 7, 12, 13, 14, and 15, respectively, L0ListIdx may be 0, 3, 2, 1, -, -, -, and -, respectively, and L1ListIdx may be -, -, -, 0, 1, 2, and 3, respectively.

In the table illustrated in FIG. 10B, for example, the frame 14, which is in substantially the same phase as the frame B8 illustrated in FIG. 2, may be assigned as a first priority forward reference frame to the frame B8, and the frames P7, P6, and P5 may be assigned as second, third, and fourth priority forward reference frames, respectively.

In the table illustrated in FIG. 10B, for example, the frame P12, which is in substantially the same phase as the frame B8 illustrated in FIG. 2, may be assigned as a first priority backward reference frame to the frame B8, and the frames P13, P14, and P15 may be assigned as second, third, and fourth priority backward reference frames, respectively.

FIG. 11 illustrates an exemplary process for generating information. For example, in FIG. 11, information of an input image management table corresponding to a sequence having an IPB structure may be generated.

In FIG. 11, information of an input image management table corresponding to FIG. 2 may be generated. The picture types (PicType) and the order of an encoding process (EncOrder) for images arranged in the input order (i) in each GOP are generated.

When the process for generating the information of the input image management table has begun, a sampling cyclic period F is obtained in an operation ST21.

In an operation ST22, the GOP structure is determined, the number L of B-groups between I/P (the number of groups of B-frames between I-frames or P-frames) is set, and the number N of frames in the GOP is set N=(L+1)×F×K. K may be a natural number (K=1, 2, 3, or the like), and N may be a multiple of (L+1)×F. The process proceeds to an operation ST23.

For example, in FIG. 2, F may be 4, L may be 1, and K may be 2. The number N of frames in the GOP may be N=(L+1)×F×K=2×4×2=16. For example, in FIG. 2, the number L of B-groups between I/P may be 1, and a group of four B-frames is processed.

In an operation ST23, i=0 is set. In an operation ST24, whether or not an expression i%(F×(L+1))<F×L is satisfied is judged. In FIG. 2, since F=4 and L=1, F×(L+1) may be 8 and F×L may be 4.

For example, in the operation ST24, i is divided by 8, and the process proceeds to an operation ST26 if the remainder is smaller than 4. If the remainder is not smaller than 4, the process proceeds to an operation ST25. For example, in FIG. 2, since the remainder is 0 to 3 when i is 0 to 3 or 8 to 11, it is judged that i%8<4, and the process proceeds to an operation ST26.

In the operation ST26, the picture type (PicType(i)) is set to a B-picture and the ENC order is set to an order obtained by adding 4 to i. The process proceeds to an operation ST30. As illustrated in FIG. 2, first to fourth (i=0 to 3) images and ninth to twelfth (i=8 to 11) images in the input order are set to B frames, and the ENC order is set to n order obtained by adding 4 to the input order number.

In the operation ST24, when judging that the expression i%8<4 is not established, the process proceeds to the operation ST25. In the operation ST25, whether or not an expression i=F×L is established is judged.

If i=F×L=4, the process proceeds to an operation ST27. The picture type (PicType(i)) is set to an I-picture, and the process proceeds to an operation ST29. As illustrated in FIG. 2, a fifth image (fifth input frame: i=4) in the input order is set to an I-frame.

If the expression i=F×L is not satisfied, the process proceeds to an operation ST28. The picture type (PicType(i)) is set to a P-picture, and the process proceeds to an operation ST29. For example, as illustrated in FIG. 2, sixth to eighth (i=5 to 7) images and thirteenth to sixteenth (i=12 to 15) images in the input order may be set to P-frames.

In the operation ST29, the order of an encoding process (EncOrder(i): ENC order) is set as EncOrder(i)=i−F×L=i−4. For example, the ENC order of I-frames and P-frames may be set to an order obtained by subtracting 4 from the input order number.

In an operation ST30, 1 is added to i (i=i+1). In an operation ST31, whether or not i==N−1 is satisfied is judged. If i==N−1 is not satisfied, the process returns to the operation ST24, and substantially the same process may be repeated. If i==N−1 is satisfied, for example, when the process performed for the number N of frames in the GOP has been completed (when the process performed for sixteen frames of i=0 to 15 has been completed), a generation of the information regarding the input image management table may be terminated.

The input image management table illustrated in FIG. 10A or an input image management table including information corresponding to the frame arrangement illustrated in FIG. 2 is generated.

FIG. 12 illustrates an exemplary process for generating information. In FIG. 12, information of an input image management table corresponding to a sequence having an IPB structure may be generated.

When the process for generating the information of the input image management table starts, a sampling cyclic period F (=4) is obtained in an operation ST41. The process proceeds to an operation ST42.

In the operation ST42, the GOP structure is determined, the number L′ of Bs between I/P (the number of B-frames between I-frames or P-frames), and the number N of frames in the GOP is set to N=LCM(L′+1, F)×K. The number L′ may be 2. The process proceeds to the operation ST43.

For example, in FIG. 3, F may be 4, L′ may be 2, and K may be 2. For example, the least common multiple (LCM) of 3 and 4 is 12, and N=LCM(L′+1, F)×K=LCM(3, 4)×2=12×2=24. For example, in FIG. 3, since the number L′ of Bs between I/P is set to 2, a group of two B-frames is processed when F=4 (four-phase cycle).

In the operation ST43, i=0 is set. In the operation ST44, whether or not i%(L′+1)=L′ is satisfied is judged. For example, in FIG. 3, since i%(L′+1)=L′, whether or not i%3=2 is judged in the operation ST44.

In the operation ST44, i is divided by 3. If the remainder is 2 after is divided by 3, the process proceeds to an operation ST45. If the remainder is not 2, the process proceeds to an operation ST46. In the operation ST45, whether or not i==L′ is satisfied is judged. If the expression i==L′ is satisfied, the process proceeds to an operation ST47.

For example, as illustrated in FIG. 3, if i=2, the process proceeds to an operation ST47, and the picture type (PicType(i) is set to an I-picture. The process proceeds to an operation ST50, and the ENC order is set to 0.

In the operation ST45, if the expression i==L′ is not satisfied, for example, when judging that i is not 2, the process proceeds to an operation ST48, and the picture type (PicType(i)) is set to a P-picture.

In the operation ST49, whether or not an expression i==2L′+1 is satisfied is judged. If the expression i==2L′+1 is satisfied, for example, if i is 5, the process proceeds to an operation ST51, and the ENC order is set to 1. The process proceeds to an operation ST56.

If the expression i 2L′+1 is not satisfied, for example, if i is not 5, the process proceeds to an operation ST52, and the ENC order (EncOrder(i)) is calculated by the following expression (1). The process then proceeds to the operation ST56.

$$EncOrder ( i ) = i - ( F * {L}^{′} - {\sum }_{n = 1}^{{L}^{′}} n ) \qquad ( 1 )$$

In the operation ST52, as illustrated in FIG. 3, for example, 5 may be subtracted from the input order numbers of ninth, twelfth, fifteenth, eighteenth, twenty-first, and twenty-fourth P-frames (P8, P11, P14, P17, P20, and P23) in the input order, in order to obtain the numbers of the ENC order.

When judging in the operation ST44 that i%3 is not 2, the process proceeds to the operation ST46, and the picture type (PicType(i)) is set to a B-picture. In an operation ST53, whether or not a frame is a first B-picture (frame) is judged. For example, if the frame is a first frame in a group of two B-frames in the input order, the process proceeds to an operation ST54. If the frame is not the first frame (if the frame is a second frame), the process proceeds to an operation ST55.

In the operation ST54, the ENC order is calculated by an expression (2). In the operation ST55, the ENC order is calculated by an expression (3). The process proceeds to an operation ST56.

$$\begin{matrix}EncOrder ( i ) = i + ( 1 + {\sum }_{n = 1}^{{L}^{′}} n ) & ( 2 ) \\ EncOrder ( i ) = i + ( 1 + {\sum }_{n = 1}^{{L}^{′}} n ) + 1 - F & ( 3 )\end{matrix}$$

In the operation ST54, for example, 4 is added to the numbers of the input order of B-frames (B3, B9, B15, and so on) illustrated in FIGS. 3, 4, 10, 16, and so on, in order to obtain the numbers of the ENC order. In operation ST55, for example, 1 is added to the numbers of the input order of B-frames (B4, B11, B16, and so on) illustrated in FIGS. 3, 5, 11, 17, and so on, in order to obtain the numbers of the ENC order.

In the operation ST56, 1 is added to i (i=i+1). In an operation ST57, whether or not i==N−1 is satisfied is judged. If i==N−1 is not satisfied, the process returns to the operation ST44, and substantially the same process may be repeated. If i==N−1 is satisfied, for example, when the process performed for the number N of frames in the GOP has been completed (when the process performed for twenty-four frames of i=0 to 23 has been completed), a generation of the information of the input image management table may be terminated.

An input image management table including information corresponding to the frame arrangement illustrated in FIG. 3 is generated.

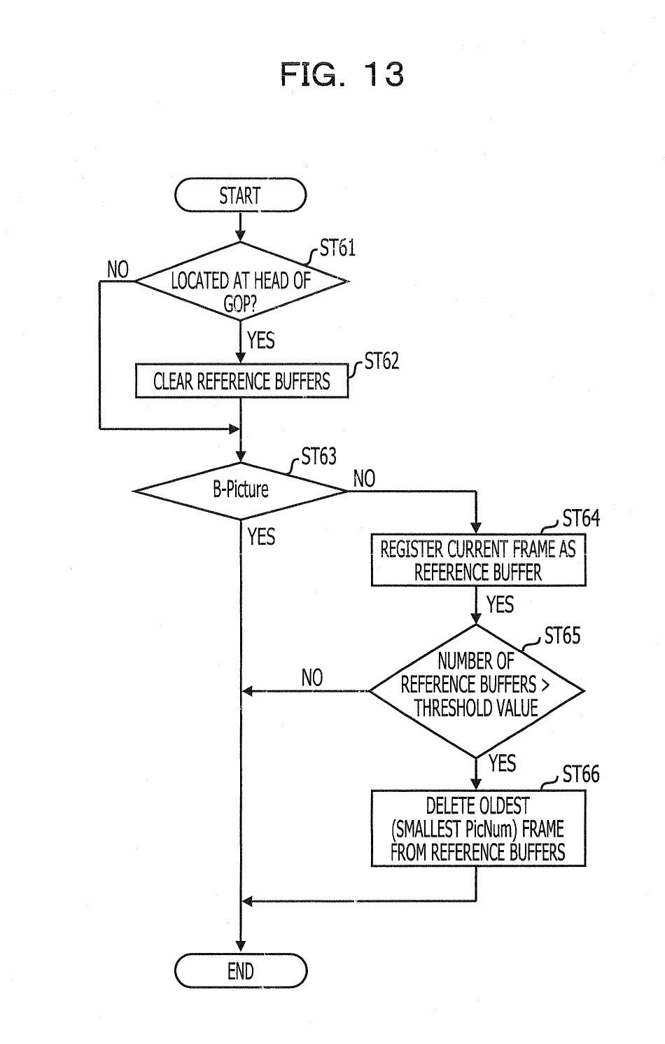

FIG. 13 illustrates an exemplary registration process. In FIG. 3, information is registered as a reference buffer. For example, RefFrame0 to RefFrame3 and RefFrame0 to RefFrame7 illustrated in FIGS. 8B and 10B, respectively, may be registered as reference buffers.

In FIG. 13, I-pictures (frames) and P-pictures are set to reference images and B-pictures are set to non-reference images.

As illustrated in FIG. 13, when a registration of reference buffers starts, whether or not a frame is located at the head of the GOP is judged in an operation ST61.

If the frame is located at the head of the GOP, the process proceeds to an operation ST62, and reference buffers are cleared. The process proceeds to an operation ST63. If the frame is not located at the head of the GOP, the process proceeds to an operation ST63.

In the operation ST63, whether or not image data is a B-picture is judged. If the image data is a B-picture, the registration of reference buffers is terminated since B-pictures are set as non-reference images. If the image data is not a B-picture, for example, if the image data is an I or P (I/P) picture, the process proceeds to an operation ST64, and the current frame (I or P-picture) is registered as a reference buffer. The process proceeds to an operation ST65.

In the operation ST65, whether or not the number of reference buffers is larger than a threshold value is judged. If the number of reference buffers is larger than the threshold value (reference buffers>threshold value), the process proceeds to an operation ST66. If the number of reference buffers is not larger than the threshold value, registration of reference buffers may be terminated.

In the operation ST66, the oldest frame, for example, a frame having the smallest number of the input order (PicNum), is deleted from reference buffers, and the registration of reference buffers may be terminated. For example, if the number of reference buffers exceeds a certain number, the oldest frame in the input order may be deleted from the reference list.

The certain number of reference buffers may be, for example, four in FIG. 1, eight in FIG. 2, and five in FIG. 3. The registration of reference buffers may be performed when encoding of frames has been completed. The registration process may be performed for each frame (picture).

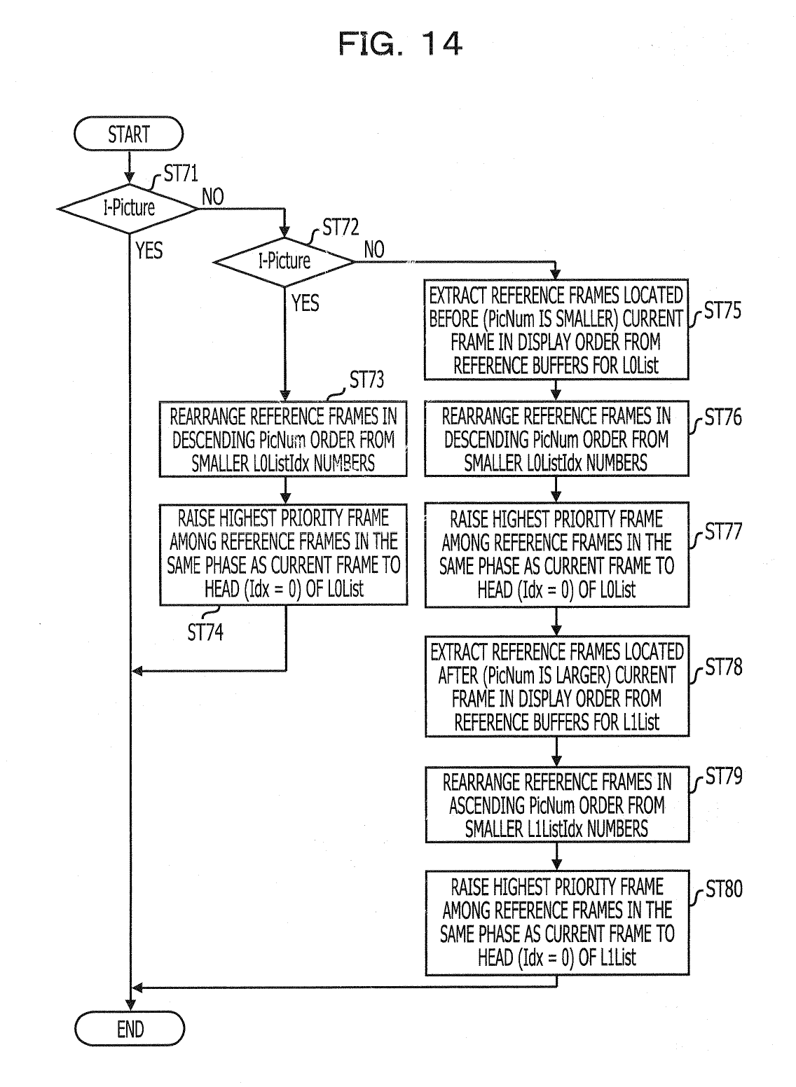

FIG. 14 illustrates an exemplary process for generating a reference list. A generation of the reference list illustrated in FIG. 14 may be performed when a process for encoding frames starts.

As illustrated in FIG. 14, when the generation of the reference list starts, whether or not image data is an I-picture is judged in an operation ST71. If the image data is an I-picture, the generation of the reference list may be terminated. If the image data is not an I-picture, the process proceeds to an operation ST72. For example, since the I-picture may not use the reference list, the generation of the reference list may be terminated.

In the operation ST72, whether or not the image data is a P-picture is judged. If the image data is a P-picture, the process proceeds to an operation ST73. Reference frames are rearranged in the descending PicNum order from smaller L0ListIndex numbers, and the process proceeds to an operation ST74.

For example, in the operation ST73, in the frame P12 illustrated in FIG. 2 whose the ENC order is ninth, the Idx numbers of the priority of newest forward reference images in L0ListIdx, for example, 0 (RefPicList0[0]) to 4 (RefPicList0[4]), are rearranged in the descending input order (PicNum). For example, the list may be generated by setting the frame P7 to RefPicList0[0], the frame P6 to RefPicList0[1], the frame P5 to RefPicList0[2], and the frame I4 to RefPicList0[3].

In the operation ST74, the highest priority frame among reference frames that are in substantially the same phase as the current frame may be set as the head (Idx=0) of L0List, and the generation of the reference list may be terminated. For example, in the operation ST74, a frame that is in substantially the same phase as the sampling phase of a frame to be encoded and that has a highest priority in the generated list, for example, has a smallest index number, is set as a highest priority frame, thereby correcting the list.

In the operation ST74, for example, since the frame I4 in RefPicList0[3] of the frame P12 illustrated in FIG. 2 whose the ENC order is ninth is in substantially the same phase as the frame P12 (current frame), Idx=0 is set. For example, the frame 14 is set to the first priority forward reference frame RefPicList0[0], and the priority of the frames P7 to P5 is reduced. The frame 14 is set to RefPicList0[0], the frame P7 is set to RefPicList0[1], the frame P6 is set to RefPicList0[2], and the frame P5 is set to RefPicList0[3].

For example, a highest priority reference frame may be in substantially the same phase as a current frame to be encoded, unless there is no frame that is in substantially the same phase among reference buffers. A frame located temporally close to a current frame to be encoded may have priority in the list.

If the image data is not a P-picture, for example, if the image data is a B-picture, the process proceeds to an operation ST75. A reference frame prior to the current frame in the display order, for example, a reference frame whose PicNum is smaller than that of the current frame in the input order are extracted from reference buffers for L0List. The process proceeds to an operation ST76.

If the image data is a B-picture, forward reference frames (L0List) and backward reference frames (L1List) may be generated. In L0List, the priority of forward reference images may be set and, in L1List, the priority of backward reference images may be set.

In an operation ST76, the reference frames are rearranged in a descending PicNum order from smaller L0ListIdx numbers. The process proceeds to an operation ST77. For example, L0List is generated by extracting frames whose PicNums are smaller (older) than that of a frame to be processed and by rearranging the extracted reference frames in a descending PicNum order from the reference frames having smaller Idx numbers.

In an operation ST77, among reference frames that are in substantially the same phase as the current frame, a highest priority frame is set to the head of L0List (Idx=0). The process proceeds to an operation ST78. The operations ST76 and ST77 may be substantially the same as or similar to the operations ST73 and ST74 performed on P-pictures.

In the operation ST78, reference frames whose PicNums are larger than that of the current frame in the display order, for example, in the input order, are extracted from reference buffers for L1List. The process proceeds to an operation ST79. In the operation ST79, the reference frames are rearranged in an ascending PicNum order from the reference frames having smaller L1ListIdx numbers. The process proceeds to an operation ST80.

For example, when L1List is generated, frames whose PicNums are larger than that of a frame to be processed, for example, future frames, are extracted, and the extracted reference frames are rearranged in an ascending PicNum order from the reference frames having smaller Idx numbers.

For example, in the operation ST78, in the frame B10 illustrated in FIG. 2 whose ENC order is fifteenth, the Idx numbers of the priority of backward reference frames having smallest numbers in L1ListIdx are rearranged from 0 (RefPicList1[0]) to 4 (RefPicList1[4]) in an ascending input (PicNum) order. For example, the frame P12 may be set to RefPicList1[0], the frame P13 may be set to RefPicList1[1], the frame P14 may be set to RefPicList1[2], and the frame P15 may be set to RefPicList1[3].

In an operation ST80, among reference frames that are in substantially the same phase as the current frame, a highest priority frame is set to the head of L1List (Idx=0), thereby correcting the list. The generation of the reference list is terminated.

In an operation ST80, for example, in the frame B10 illustrated in FIG. 2 whose ENC order is fifteenth, since the frame P14, which is set to RefPicList1[2], is in substantially the same phase as the frame B10, which is the current frame, the frame P14 is set to Idx=0. The frame P14 may be set to RefPicList1[0], the frame P12 may be set to RefPicList1[1], the frame P13 may be set to RefPicList1[2], and the frame P15 may be set to RefPicList[3].

In L0List and L1List, highest priority reference frames are in substantially the same phase as a current frame to be processed, unless there is no frame that is in substantially the same phase among reference buffers. A reference frame temporally close to the current frame to be processed is preferentially registered in the list.

FIG. 15 illustrates an exemplary image processing system. The image processing system illustrated in FIG. 15 includes a moving image recording apparatus 10, a moving image playing apparatus 20, a transmitter 31, and a receiver 32.

The moving image recording apparatus 10 includes a control circuit 11, an image input circuit 12, a subsampling circuit 130, an H.264 encoding circuit 140, and a memory 15. The subsampling circuit 130 includes a fixed subsampling portion 131 and a cyclic subsampling portion 132. The H.264 encoding circuit 140 includes a first encoder 141, a second encoder 142, and a multiplexer 143.

The image input circuit 12 includes, for example, an image sensor or the like, and supplies image data (an image sequence) to the fixed subsampling portion 131 and the cyclic subsampling portion 132 of the subsampling circuit 130.

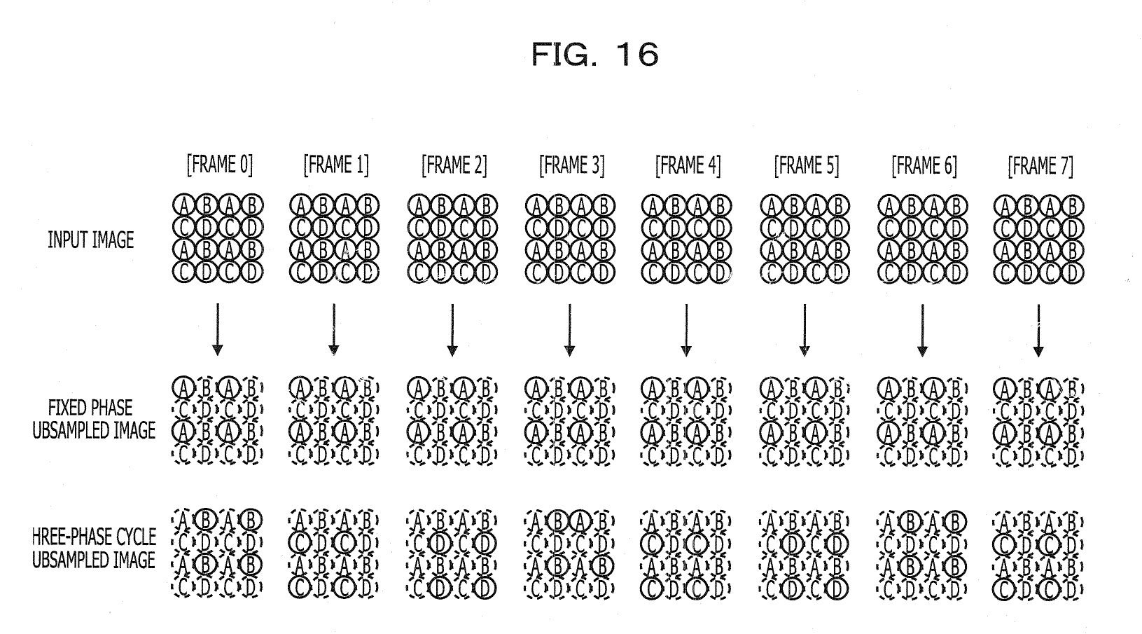

The fixed subsampling portion 131 processes an image sequence supplied from the image input circuit 12. For example, as illustrated in FIG. 16, the fixed subsampling portion 131 reduces the number of sampling positions, generates a subsampled image and stores the subsampled image in the memory 15.

The cyclic subsampling portion 132 processes an image sequence supplied from the image input circuit 12. As illustrated in FIG. 16, the cyclic subsampling portion 132 reduces the number of sampling positions while changing the sampling positions in a period F, generates subsampled image and stores the subsampled image in the memory 15.

The first encoder 141 and the second encoder 142 of the H.264 encoding circuit 140 read subsampled images from the memory 15 and encodes the subsampled images in accordance with the H.264 standard. The encoded data is supplied to the multiplexer 143. The above process may be, for example, controlled by the control circuit 11 including a CPU.

The moving image playing apparatus 20 includes a control circuit 21, an H.264 decoding circuit 220, a composite circuit 230, a display circuit 24, a memory 25, and a display selection circuit 26. The H.264 decoding circuit 220 includes a demultiplexer 223 that receives data from the moving image recording apparatus 10 through the transmitter 31 and the receiver 32, a first decoder 221, and a second decoder 222.

The first decoder 221 and the second decoder 222 of the H.264 decoding circuit 220 receive subsampled images from the demultiplexer 223 and decode the subsampled images in accordance with the H.264 standard. The decoded image data is stored in the memory 25. The composite circuit 230 reads the image data from the memory 25 and generates an interpolated image and supplies the interpolated image to the display selection circuit 26.

The display selection circuit 26 selects either image data read from the memory 25 or image data supplied from the composite circuit 230, and displays the selected image data with the display circuit 24. The image data supplied from the memory 25 to the display selection circuit 26 may, for example, include a low-resolution image such as an image of full HD. The image data supplied from the composite circuit 230 to the display selection circuit 26 may, for example, include a high-resolution image such as an image of 4k2k.

An image supplied from the image input circuit 12 to the subsampling circuit 130 may, for example, include a high-resolution image such as an image of 4k2k. Subsampled image generated by the fixed subsampling portion 131 and the cyclic subsampling portion 132 and an image transmitted from the transmitter 31 to the receiver 32 may, for example, include a low-resolution image such as an image of full HD.

In FIG. 15, data from the moving image recording apparatus 10 is supplied to the moving image playing apparatus 20 through the transmitter 31 and the receiver 32. The transmitter 31 and the receiver 32 may be, for example, replaced by a storage apparatus as illustrated in FIG. 4.

FIG. 16 illustrates an exemplary image process. Subsampled images may be generated using a fixed phase and a three-phase cycle. In FIG. 16, as illustrated in FIG. 15, two types of subsampled images are generated by fixed phase subsampling and cyclic phase subsampling performed by the fixed subsampling portion 131 and the cyclic subsampling portion 132, respectively.

As illustrated in FIG. 16, for example, the number of pixel positions is reduced by half in both the vertical and horizontal directions. The fixed phase subsampling is performed in one phase, for example, Phase A. The cyclic phase subsampling is performed in three phases, for example, Phase B, Phase C, and Phase D. The size of an image after the reduction may be ¼ of that of an input image.

For example, in the fixed phase subsampling of the fixed subsampling portion 131, four pixels A that are in substantially the same phase in Frames 0 to 7 of an input image having 4×4=16 pixels are obtained. Therefore, one-phase cycle subsampled image is obtained.

In the cyclic phase subsampling of the cyclic subsampling portion 132, four pixels B in Frame 0 which is the first frame of an input image having 4×4=16 pixels are obtained and four pixels C in the next Frame 1 are obtained.

Four pixels D in the next Frame 2 are obtained. Four pixels B that are in substantially the same phase as the pixels B that have been obtained in Frame 0 are obtained in the next Frame 3. The same process may be repeated. Three-phase cycle subsampled images are obtained.

The H.264 encoding circuit 140 illustrated in FIG. 15 reads the two types of sampled image sequences in the memory 15, supplies the sampled image sequences to the first encoder 141 and the second encoder 142, respectively and encodes the sampled image sequences in accordance with H.264.

During the encoding, the H.264 encoding circuit 140 writes a locally decoded image to the memory 15 and reads a reference image from the memory 15. The two generated H.264 streams may be multiplexed by the multiplexer 143 and supplied to the transmitter 31.

The H.264 encoding circuit 140 illustrated in FIG. 15 includes the first encoder 141 and the second encoder 142. For example, either the first encoder 141 or the second encoder 142 may perform a time-division process. Two H.264 streams may not be processed arid, for example, a single stream may be generated by Multiview Video Coding(MVC).

The generated streams may be supplied to the moving image playing apparatus 20 through the transmitter 31 and the receiver 32. H.264 streams supplied to the moving image playing apparatus 20 are decoded by the H.264 decoding circuit 220.

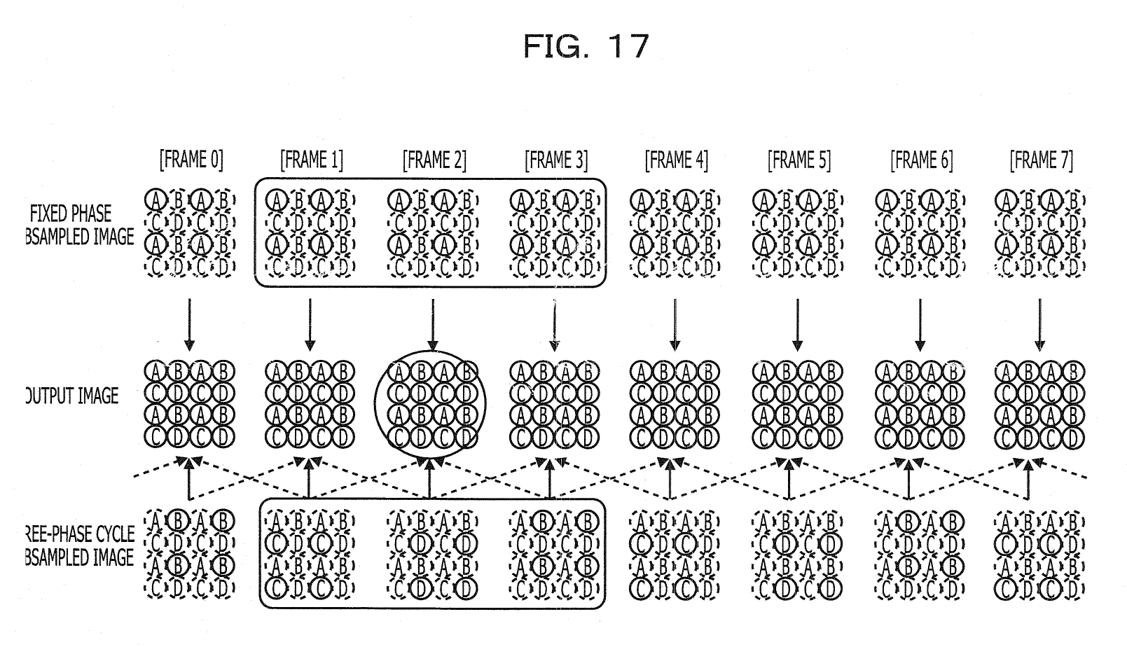

FIG. 17 illustrates an exemplary generation of an interpolated image. The interpolated image may be generated from subsampled images generated by the fixed phase subsampling and the three-phase cycle subsampling. The composite circuit 230 illustrated in FIG. 17 generates the interpolated image from a fixed phase subsampled image and three-phase cycle subsampled images.

In the H.264 decoding circuit 220, H.264 streams may be demultiplexed, for example, divided, into streams of a fixed phase subsampled image sequence and a cyclic phase subsampled image sequence by the demultiplexer 223.

The stream of the fixed phase subsampled image sequence, for example, the stream of the fixed phase subsampled image, is supplied to the first decoder 221 and decoded. The stream of the cyclic phase subsampled image sequence, for example, the stream of the three-phase cycle subsampled image, is supplied to the second decoder 222 and decoded.

During the decoding, the H.264 decoding circuit 220 reads a reference image from the memory 25 and writes a decoded image to the memory 25. The size of the decoded image written to the memory 25 may be ¼ of that of an input image.

The composite circuit 230 generates a display image by increasing the size of the decoded image from ¼ to the original size through interpolation. The image having the ¼ size that is input to the composite circuit 230 may be, for example, a low-resolution image of full HD. An image output from the composite circuit 230 may be, for example, a high-resolution image of 4k2k.

The composite circuit 230 may perform the interpolation using an image located close temporally. For example, detection of movement is performed for each region. In a region in which there is no movement, inter-frame interpolation may be performed using pixels located in corresponding sampling positions of a close frame. In a region in which there is movement, intra-frame interpolation may be performed using surrounding pixels in the decoded frame.

For example, pixels of a fixed phase subsampled image and cyclic phase subsampled image may be used in Phases A and D of an encircled output image illustrated in FIG. 17, and pixels in Phases B and C may be generated by interpolation.

Detection of movement may be performed between Frames 1, 2, and 3 of fixed phase subsampled images. When judging that there is no movement in a region, the pixels in Phases B and C are interpolated using images of Frames 1 and 3 of cyclic phase subsampling. When judging that there is movement in a region, the pixels in Phases B and C may be interpolated using surrounding pixels in Phases A and D of Frame 2.

The display selection circuit 26 selects either a frame having an original image size that has been generated through interpolation performed by the composite circuit 230 or a frame of a fixed phase image sequence. The selected image may be displayed by the display selection circuit 26.

Two types of subsampled image sequences may be generated by the fixed phase subsampling and the cyclic phase subsampling. If an image having a small size, for example, a ¼ size of an original image, is displayed on the playing side, the image sequence of the fixed phase subsampling is displayed. If an image having a large size, for example, an original image size, is displayed on the playing side, both the image sequence of the fixed phase subsampling and the image sequence of the cyclic phase subsampling are used to generate an interpolated image.

In FIGS. 15 to 17, the cyclic phase F of sampling positions may be 3.

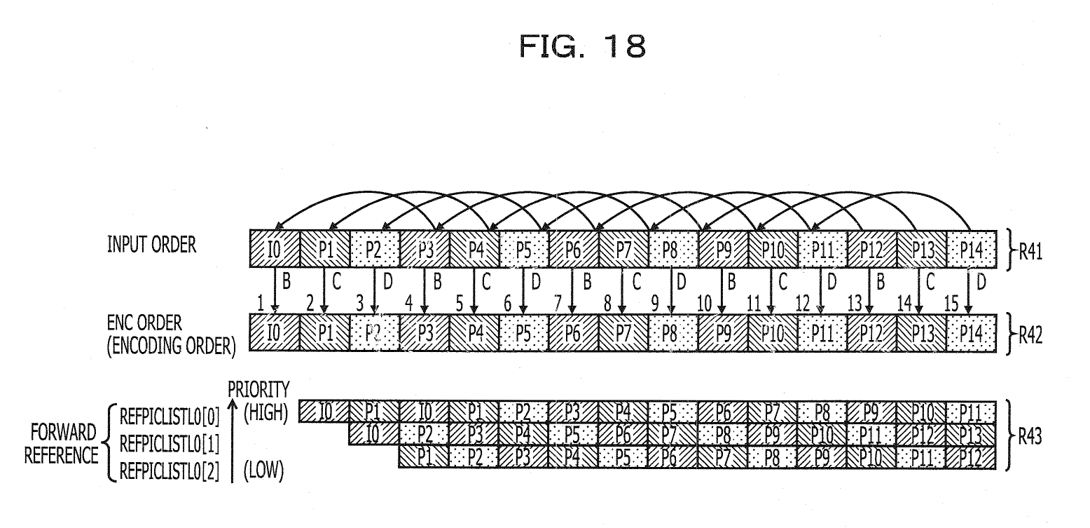

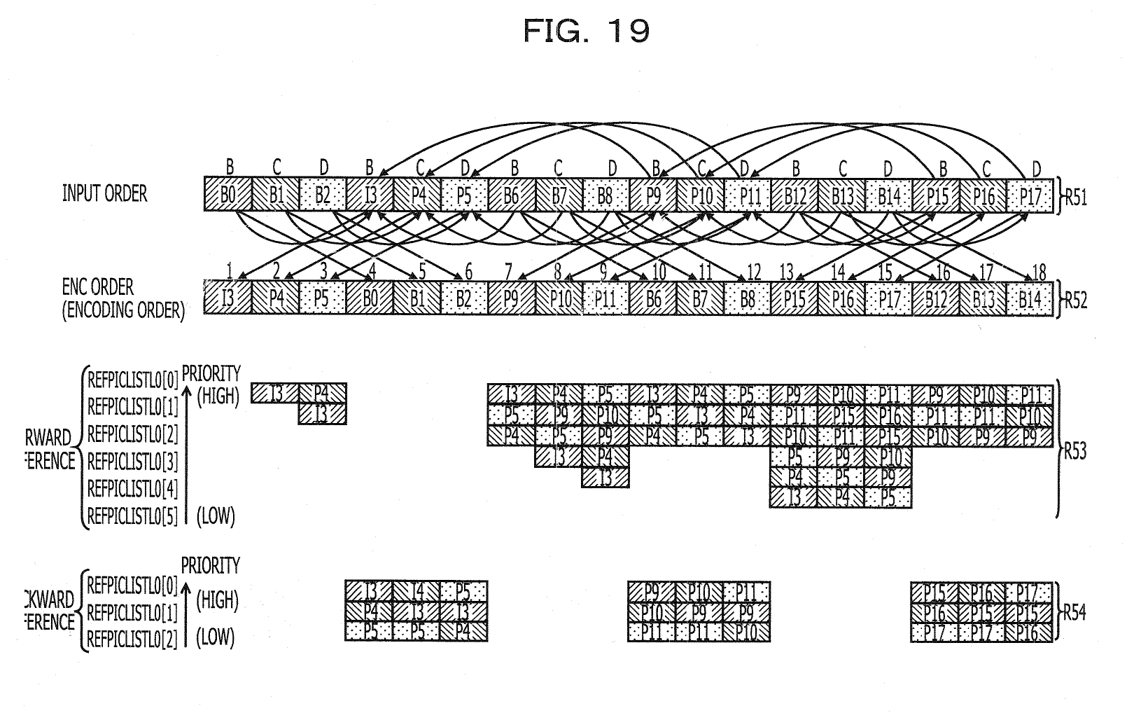

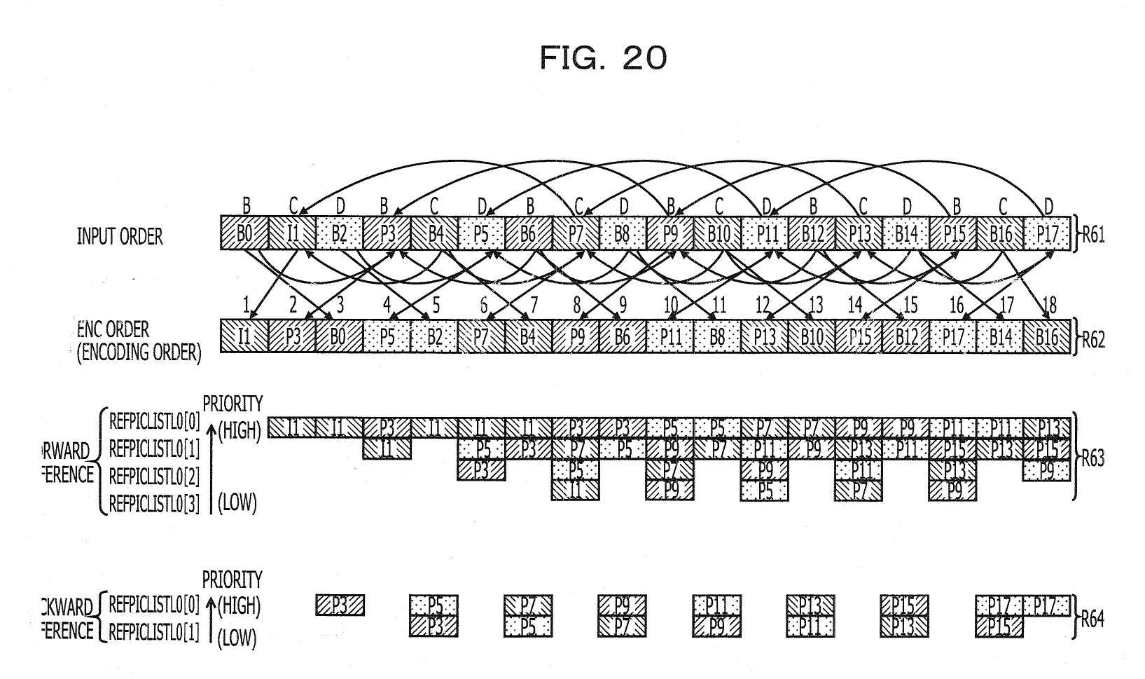

FIG. 18 illustrates an exemplary image process. FIG. 19 illustrates an exemplary image process. FIG. 20 illustrates an exemplary image process. The cyclic period F of sampling positions may be 3.

For example, in FIG. 18, the cyclic period F of sampling positions when the I and P-pictures (frames) illustrated in FIG. 1 are processed may be set to 3.

Regions R41, R42, and R43 illustrated in FIG. 18 may correspond to the regions R11, R12, and R13, respectively, illustrated in FIG. 1. In FIG. 18, F may be 3 and K may be 5. The number of frames in the GOP may be 15.

In FIG. 19, when the I, P, and B-pictures illustrated in FIG. 2 are processed, the cyclic period F of sampling positions may be 3.

Regions R51, R52, R53, and R54 illustrated in FIG. 19 may correspond to the regions R21, R22, R23, arid R24, respectively, illustrated in FIG. 2. In FIG. 19, F may be 3, L may be 1, and K may be 3. The number of frames in the GOP may be 18.

The processes for generating information regarding input image management tables illustrated in FIGS. 9 and 11 may be used.

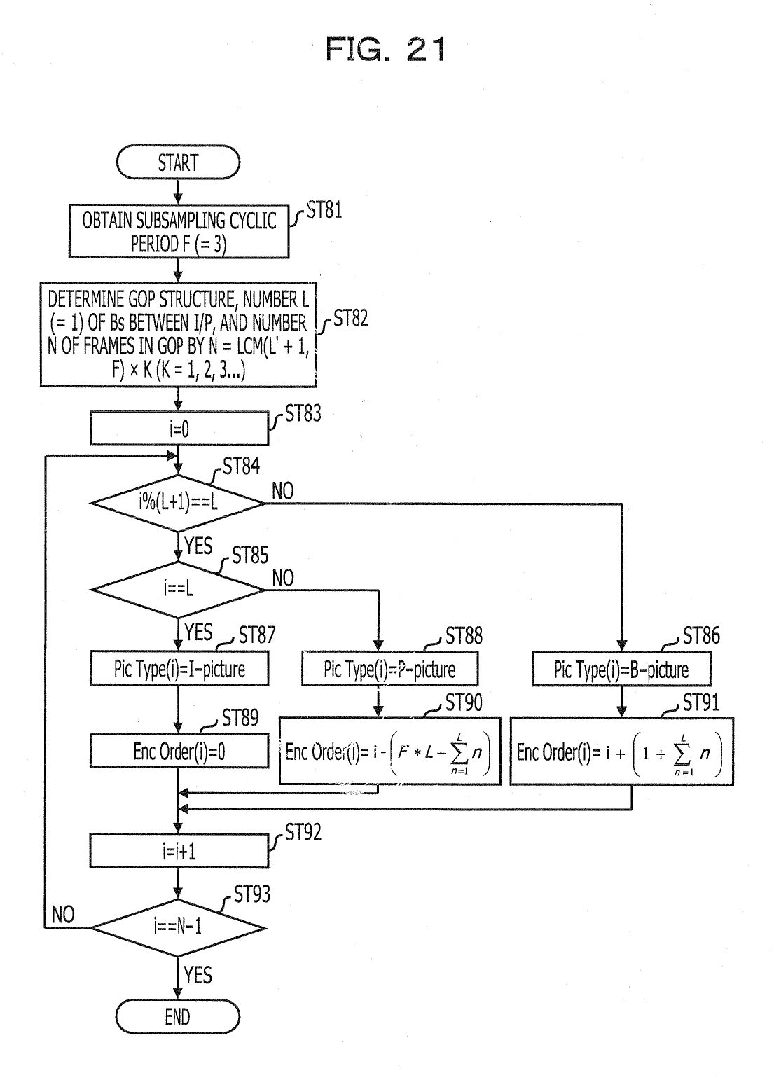

In FIG. 20, when the I, P, and B-pictures illustrated in FIG. 3 are processed, the cyclic period F of sampling positions may be set to 3. A process for generating information of an input image management table illustrated in FIG. 21 may be used.

Regions R61, R62, R63, and P64 illustrated in FIG. 20 may correspond to the regions R31, R32, R33, and R34 illustrated in FIG. 3. In FIG. 20, F may be 3, L may be 1, and K may be 3. The number of frames in the GOP may be 18.

FIG. 21 illustrates an exemplary process for generating information. For example, in FIG. 21, information of an input image management table corresponding to a sequence having an IPB structure may be generated.

Operations ST81 to ST88 illustrated in FIG. 21 correspond to the operations ST41 to ST48, respectively, illustrated in FIG. 12. In the process for generating information of an input image management table illustrated in FIG. 21, the sampling cyclic period F (=3) is obtained in the operation ST81. The process proceeds to the operation ST82.

In the operation ST82, the GOP structure is determined, the number L of B-frames between I or P-frames (the number of Bs between I/P) is, for example, set to 1, and the number N of frames in the GOP is set by an expression N=LCM(L+1, F)×K.

For example, in FIG. 20, F may be 3, L may be 2, and K may be 3. For example, the LCM of 2 and 3 is 6, and N=LCM(L+1, F)×K=LCM(2, 3)×3=6×3=18. In FIG. 20, since the number L of Bs between I/P is 1, one B frame is processed when F=3, for example, when a three-phase cycle is used.

In the operation ST84, i is divided by 3. If the remainder is 2, whether or not an expression i==L is satisfied is judged in the operation ST85. If the expression i==L′ is satisfied, the process proceeds to the operation ST87.

If i=1, the process proceeds to the operation ST87, and the picture type (PicType(i)) is set to an I-picture. The process proceeds to the operation ST89, and the ENC order is set to 0. The process proceeds to the operation ST92.

If the remainder is not 2 after i is divided by 3 in the operation ST84, the process proceeds to the operation ST86, and the picture type (PicType(i)) is set to a B-picture. The process proceeds to the operation ST91.

When judging that the expression i==L is not satisfied in operation ST85, for example, when judging that i is not 1, the process proceeds to the operation ST88, and the picture type (PicType(i)) is set to a P-picture. The process proceeds to the operation ST90.

The operation ST90 may correspond to the operation ST52 illustrated in FIG. 12. The ENC order (EncOrder(i)) is calculated by an expression (4), and the process proceeds to the operation ST92. The operation ST91 may correspond to the operation ST54 illustrated in Hg. 12. The ENC order (EncOrder(i)) is calculated by an expression (5), and the process proceeds to the operation ST92.

$$\begin{matrix}EncOrder ( i ) = i - ( F * L - {\sum }_{n = 1}^{L} n ) & ( 4 ) \\ EncOrder ( i ) = i + ( 1 + {\sum }_{n = 1}^{L} n ) & ( 5 )\end{matrix}$$

In the operation ST90, 2 may be subtracted from the numbers of the input order of fourth, sixth, eighth, tenth, and so on, and eighteenth P-frames (P3, P5, P7, P9 . . . P17) in the input order, in order to obtain the numbers of the ENC order.

In the operation ST91, 2 may be added to the numbers of the input order of first, third, fifth, seventh, and so on, and fifteenth B-frames (B0, B2, B4, B6 . . . B14) in the input order, in order to obtain the numbers of the ENC order. The ENC order of a seventeenth B-frame (B16) in the input order becomes 18 by adding 1 based on the number N of frames in the GOP, which is 18.

In the operation ST92, 1 is added to i (i=i+1). The process proceeds to the operation ST93, and whether or not an expression i==N−1 is satisfied is judged. When the expression i==N−1 is not satisfied, the process returns to the operation ST84, and the same process may be repeated. When the expression i==N−1 is satisfied, generation of the information regarding the input image management table may be terminated when, for example, the process of the number N of frames in the GOP has been completed (when the process of eighteen frames of i=0 to 17 has been completed).

An input image management table including information corresponding to the frame arrangement illustrated in FIG. 20 is generated.

The compression efficiency may be improved when an image sequence including images whose sampling positions of pixels are different from one another is compressed using a moving image decoding standard adopting inter-frame prediction.

A moving image sequence for a high-resolution image is encoded by a high compression ratio based on a plurality of images whose sampling positions of pixels are different from one another. Therefore, the amount of data of sequences to be recorded may be reduced and the bandwidth to be used to transmit the sequences may be reduced.

The cyclic period F of sampling positions may be set to an integer of 2 or more. The cyclic period F may be, for example, changed based on the bit rate at which the transmitter 31 and the receiver 32 illustrated in FIG. 15 communicate with each other or the image quality to be required. For example, the cyclic period F may be dynamically set in accordance with changes in the bit rate.

Example embodiments of the present invention have now been described in accordance with the above advantages. It will be appreciated that these examples are merely illustrative of the invention. Many variations and modifications will be apparent to those skied in the art.

1. An image processing apparatus comprising:
a subsampling circuit configured to generate a subsampled image based on a sampling position of each one of a frame of an input image;
a control circuit configured to assign a frame at a sampling position which is substantially the same as a sampling position of a frame to be encoded as a reference frame based on information of the sampling position of each frame and a structure of a group of pictures; and
an encoder configured to encode the frame to be encoded by compressing the frame to be encoded using inter-frame prediction based on a subsampled image of the frame to be encoded and the reference frame.

2. The image processing apparatus according to claim 1,
wherein the subsampling circuit changes the sampling position of each frame in a certain period in an input order of the input image.

3. The image processing apparatus according to claim 2,
wherein the control circuit is configured to assign a frame at a sampling position which changes in the certain period and has substantially the same phase as the phase of the frame to be encoded as the reference image.

4. The image processing apparatus according to claim 1,
wherein the structure of the group of pictures includes an I-frame, a frame, or a B-frame.

5. The image processing apparatus according to claim 4,
wherein the control circuit is configured to assign a frame, which is one of an I-frame and a P-frame prior to the frame to be encoded in an input order and is at a sampling position that is substantially the same as the sampling position of the frame to be encoded, as a first priority forward reference frame when the frame to be encoded is a P-frame.

6. The image processing apparatus according to claim 5,
wherein the control circuit is configured to assign a frame, which is one of an I-frame and a P-frame prior to the frame to be encoded in an input order and is at a sampling position that is substantially the same as the sampling position of the frame to be encoded, as a first priority forward reference frame and assigns a frame, which is one of an I-frame and a P-frame behind the frame to be encoded in the input order and is at a sampling position that is substantially the same as the sampling position of the frame to be encoded, as a first priority backward reference frame, when the frame to be encoded is a B-frame.

7. The image processing apparatus according to claim 5,
wherein the control circuit is configured to assign a frame prior to the frame to be encoded by a certain number of frames in an input order as a first priority forward reference frame when the frame to be encoded is a P-frame, and
the control circuit is configured to assign a frame, which is one of an I-frame and a P-frame prior to the frame to be encoded in an input order and is at a sampling position that is substantially the same as the sampling position of the frame to be encoded, as a first priority forward reference frame and assigns a frame, which is one of an I-frame and a P-frame behind the frame to be encoded in the input order and is at a sampling position that is substantially the same as the sampling position of the frame to be encoded, as a first priority backward reference frame when the frame to be encoded is a B-frame.

8. The image processing apparatus according to claim 1,
wherein the control circuit is configured to generate a reference image management table for managing reference images in accordance with priority of the frame to be encoded based on information of the sampling position of the frame to be encoded and the structure of the group of pictures.

9. The image processing apparatus according to claim 8,
wherein the control circuit is configured to generate an input image management table configured for representing a relationship between an input order and an encoding order based on the information of the sampling position of the frame to be encoded and the structure of the group of pictures.

10. A method for processing an image, the method comprising:
generating a subsampled image based on a sampling position of each one of a frame of an input image;
assigning a frame at a sampling position which is substantially the same as a sampling position of a frame to be encoded as a reference frame based on information of the sampling position of each frame and a structure of a group of pictures; and
encoding the frame to be encoded by compressing the frame to be encoded using inter-frame prediction based on a subsampled image of the frame to be encoded and the reference frame.

11. The method for processing an image according to claim 10, further comprising,
changing the sampling position of each frame in a certain period in an input order of the input image.

12. The method for processing an image according to claim 11, further comprising,
assigning a frame at a sampling position, which changes in the certain period and has substantially the same phase as the phase of the frame to be encoded, as the reference image.

13. The method for processing an image according to claim 10,
wherein the structure of the group of pictures includes an I-frame, a P-frame, or a B-frame.

14. The method for processing an image according to claim 13, further comprising,
assigning a frame, which is one of an I-frame and a P-frame prior to the frame to be encoded in an input order and is at a sampling position that is substantially the same as the sampling position of the frame to be encoded, as a first priority forward reference frame when the frame to be encoded is a P-frame.

15. The method for processing an image according to claim 14, further comprising,
assigning a frame, which is one of an I-frame and a P-frame prior to the frame to be encoded in an input order and is at a sampling position that is substantially the same as the sampling position of the frame to be encoded, as a first priority forward reference frame and assigning a frame, which is one of an I-frame and a P-frame behind the frame to be encoded in the input order and is at a sampling position that is substantially the same as the sampling position of the frame to be encoded, as a first priority backward reference frame, when the frame to be encoded is a B-frame.

16. The method for processing an image according to claim 14, further comprising;
assigning a frame prior to the frame to be encoded by a certain number of frames in an input order as a first priority forward reference frame when the frame to be encoded is a P-frame; and
assigning a frame, which is one of an I-frame and a P-frame prior to the frame to be encoded in an input order and is at a sampling position that is substantially the same as the sampling position of the frame to be encoded, as a first priority forward reference frame and assigns a frame, which is one of an I-frame and a P-frame behind the frame to be encoded in the input order and is at a sampling position that is substantially the same as the sampling position of the frame to be encoded, as a first priority backward reference frame when the frame to be encoded is a B-frame.

17. The method for processing an image according to claim 10, further comprising,
generating a reference image management table configured for managing reference images in accordance with priority of the frame to be encoded based on information of the sampling position of the frame to be encoded and the structure of the group of pictures.

18. The method for processing an image according to claim 17, further comprising,
generating an input image management table configured for representing a relationship between an input order and an encoding order based on the information of the sampling position of the frame to be encoded and the structure of the group of pictures.
